(19) United States
(12) Patent Application Publication
(10) Pub. No.: US 2015/0233450 A1
(43) Pub. Date: Aug. 20, 2015

(54) CONE WITH MEMBER CVT FOR WHICH BELT TENSION CAN BE REDUCED

(71) Applicant: Armin Sebastian Tay, West Covina, CA (US)

(72) Inventor: Armin Sebastian Tay, West Covina, CA (US)

(21) Appl. No.: 14/475,492

(22) Filed: Sep. 2, 2014

Related U.S. Application Data
(63) Continuation-in-part of application No. 14/182,306, filed on Feb. 18, 2014.
(60) Provisional application No. 61/978,922, filed on Apr. 13, 2014.
(60) Provisional application No. 61/984,799, filed on Apr. 27, 2014.
(60) Provisional application No. 61/985,436, filed on Apr. 28, 2014.
(60) Provisional application No. 61/986,095, filed on Apr. 29, 2014.
(60) Provisional application No. 62/006,279, filed on Jun. 2, 2014.
(60) Provisional application No. 62/007,372, filed on Jun. 3, 2014.
(60) Provisional application No. 62/007,377, filed on Jun. 3, 2014.
(60) Provisional application No. 61/953,847, filed on Mar. 16, 2014.
(60) Provisional application No. 61/987,716, filed on May 2, 2014.
(60) Provisional application No. 61/988,294, filed on May 4, 2014.
(60) Provisional application No. 61/991,612, filed on May 11, 2014.
(60) Provisional application No. 61/994,937, filed on May 18, 2014.
(60) Provisional application No. 62/038,370, filed on Aug. 18, 2014.

(51) Int. Cl. F16H 7/12; F16H 9/08

(52) U.S. Cl. CPC F16H 7/1263; F16H 9/08

(57) ABSTRACT

A CVT 6 (FIG. 5) comprising of two substantially identical CVT 4's. Each CVT 4 comprises of two cones that are coupled by a transmission belt. The driving cones of the CVT 4's are mounted on a common shaft, and the driven cones of the CVT 4's are mounted on a common shaft. For each CVT 4, one of its cones is mounted on its shaft using an adjuster that can lock or release the rotational position of its cone relative to the shaft it is mounted. Each CVT 4 has a tense side tensioning/support pulley and a slack side tensioning/support pulley (FIG. 6) which can provide and remove slack as needed to compensate for “Transmission ratio change rotation”, to accommodate for the transmission diameter change of a cone, and to compensate for having cones of different diameters mounted on the same shaft during axial position changing of a cone.

### CROSS-REFERENCE TO RELATED APPLICATIONS

This invention is a Continuation-in-part (CIP) of U.S. patent application Ser. No. 14/182,306, which was filed on 18 Feb. 2014; in addition, this invention is entitled to the benefits of:
Provisional Patent Application (PPA) Ser. No. 61/978,922 filed on Apr. 13, 2014
Provisional Patent Application (PPA) Ser. No. 61/984,799 filed on Apr. 27, 2014
Provisional Patent Application (PPA) Ser. No. 61/985,436 filed on Apr. 28, 2014
Provisional Patent Application (PPA) Ser. No. 61/986,095 filed on Apr. 29, 2014
Provisional Patent Application (PPA) Ser. No. 62/006,279 filed on Jun. 2, 2014
Provisional Patent Application (PPA) Ser. No. 62/007,372 filed on Jun. 3, 2014
Provisional Patent Application (PPA) Ser. No. 62/007,377 filed on Jun. 3, 2014
Provisional Patent Application (PPA) Ser. No. 61/953,847 filed on Mar. 16, 2014
Provisional Patent Application (PPA) Ser. No. 61/987,716 filed on May 2, 2014
Provisional Patent Application (PPA) Ser. No. 61/988,294 filed on May 4, 2014
Provisional Patent Application (PPA) Ser. No. 61/991,612 filed on May 11, 2014
Provisional Patent Application (PPA) Ser. No. 61/994,937 filed on May 18, 2014
Provisional Patent Application (PPA) Ser. No. 62/038,370 filed on Aug. 18, 2014

The following patent and patent applications have no legal bearing on this application; they describe items mentioned in this application (i.e. cone with one torque transmitting member), but the subject matter claimed is different and/or has not been previously disclosed:
U.S. Pat. No. 7,722,490 B2, which was filed on Oct. 29, 2007
U.S. patent application Ser. No. 13/629,613, which was filed on Sep. 28, 2012
U.S. patent application Ser. No. 13/730,958, which was filed on Dec. 29, 2012
U.S. patent application Ser. No. 13/889,049, which was filed on May 7, 2013

### BACKGROUND

1. Field of Invention

This invention relates to torque/speed transmissions, specifically to a method for reducing the tension in the transmission belts of torque/speed transmissions.

2. Description of Prior Art

A CVT that has the potential to replace automatic and manual transmissions in vehicles is a CVT 4, which is described in U.S. patent application Ser. Nos. 13/629,613, 13/730,958, and 13/889,049.

A CVT 4, which is shown in FIGS. 1 to 4, has one cone with one torque transmitting member mounted on one shaft/spline that is coupled to another cone with one torque transmitting member mounted on another shaft/spline by a transmission belt.

A CVT 4 is promising design because it can allow for the construction of non-friction dependent CVT's without using ratcheting or reciprocating mechanisms. However, if a CVT 4 is transmitting a large torque, then the tension in the transmission belt of the CVT 4 is also large. And sliding a transmission belt under large tension from small diameter of its cone to a large diameter of its cone will also require a large force.

The intent of this disclosure is to describe a CVT 6 that has two CVT 4's for which the transmission belt tension in one of the CVT 4's can be reduced using a novel and non-obvious approach. An obvious approach to reduce transmission belt tension in one of the CVT 4's is by using clutches, this approach makes the transmission ratio changing duration too long for the CVT to be practical (a CVT has a lot more transmission ratios than an manual transmission and as such transmission ratio changing in a CVT occurs much more frequently than in a manual transmission). In addition, using clutches also causes considerable energy losses.

The CVT 6 of this disclosure can significantly: reduce the transmission ratio changing force needed, shock loads that occur during transmission ratio changing, and wear due to transmission ratio changing. As such the CVT 6 of this disclosure can allow for the construction of a more practical, efficient, and economical toothed CVT that has a better chance succeed commercially.

### Other Prior Arts

The following prior art that might also be relevant: U.S. Pat. No. 7,713,153; Issue Date: May 11, 2010; Patentee: Naude.

### BRIEF SUMMARY OF THE INVENTION

A CVT 6 that has two CVT 4's for which the transmission belt tension in one of the CVT 4's can be reduced using a novel and non-obvious approach.

The configuration of a CVT 6 can allow for the construction of a CVT that replaces automatic and manual transmissions as the transmission of choice in cars. Since a CVT can provide more gear ratios than manual and automatic transmissions, this will result in better performance and fuel efficiency of cars. This is a solution that is long felt needed and has been often attempted without success.

### BRIEF DESCRIPTION OF THE SEVERAL VIEWS OF THE DRAWING

FIG. 1 shows a front-view of a CVT 4.

FIG. 2 shows a top-view of a CVT 4.

FIG. 3 shows another front-view of a CVT 4.

FIG. 4 shows another top-view of a CVT 4.

FIG. 5 shows a top-view of the preferred CVT 6.

FIG. 6 shows front-view of the preferred CVT 6.

FIG. 7 shows front-view of a tensioning pulley 14 that is not engaged with its maximum contraction stop 15.

FIG. 8 shows a top-view of a CVT 6 that uses an adjuster 8 for each cone.

FIG. 9 shows a top-view of a CVT 4 for which one cone is mounted on its shaft/spline using an adjuster 8.

FIG. 10 shows a schematic diagram for CVT that uses a pre-transmission.

FIG. 11 shows a schematic diagram for CVT that uses a post-transmission.

FIG. 12 shows a schematic diagram for CVT that uses a pre-transmission and post-transmission.

FIG. 13 shows a schematic diagram for Drive System 1.

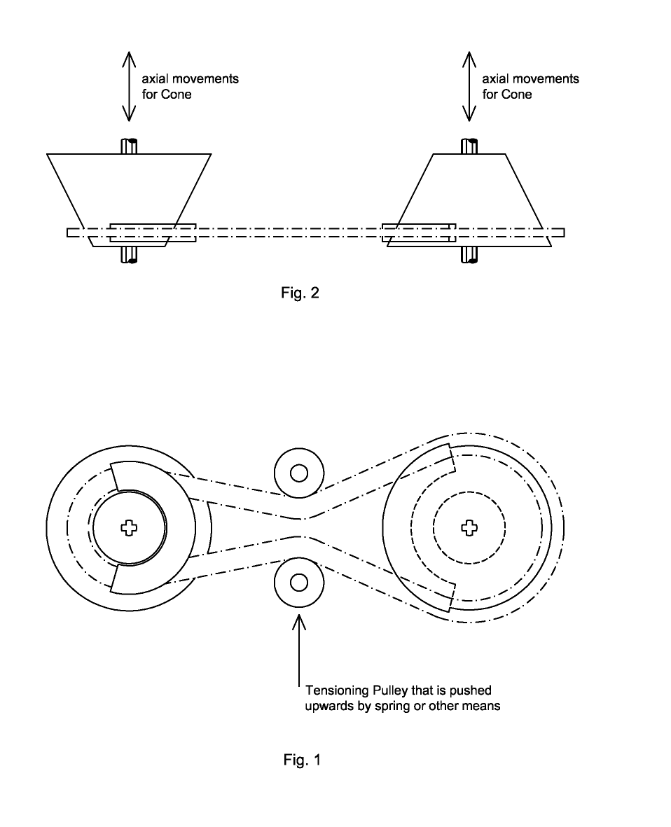

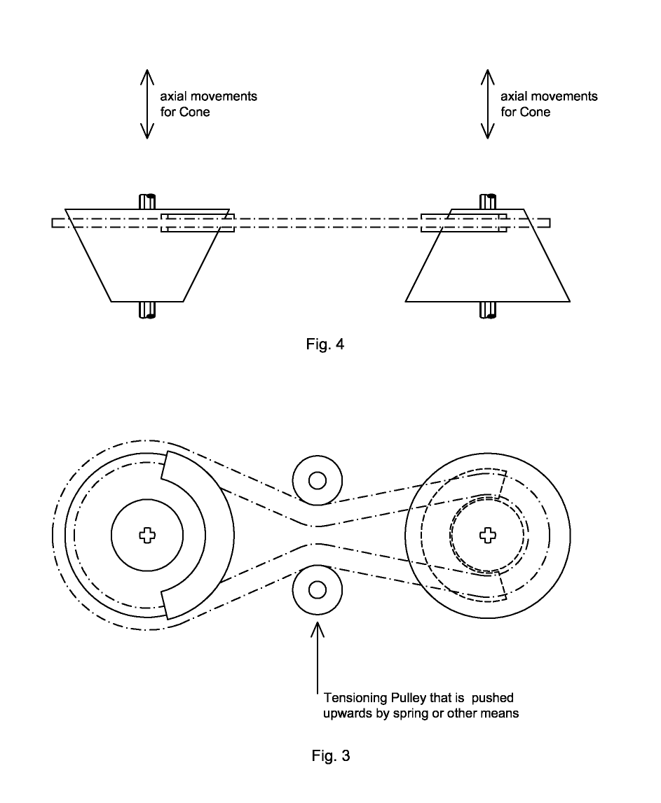

### DETAILED DESCRIPTION OF THE INVENTION

### CVT 6

### Configuration of a CVT 6

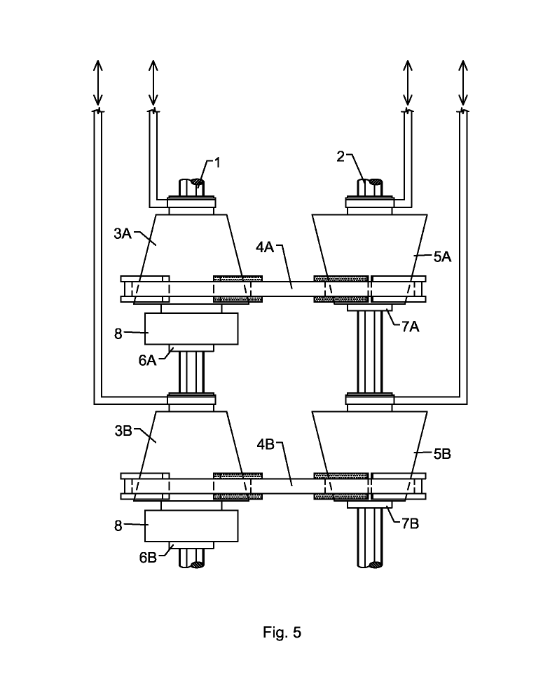

Labeling for CVT 6 shown as a top-view in FIG. 5: Input Spline 1, Output Spline 2, Driving Cone 3A of CVT 4A, Transmission Belt 4A of CVT 4A, Driven Cone 5A of CVT 4A, Slider Sleeve 6A of Driving Cone 3A, Slider Sleeve 7A of Driven Cone 5A, Driving Cone 3B of CVT 4B, Transmission Belt 4B of CVT 4B, Driven Cone 5B of CVT 4B, Slider Sleeve 6B of Driving Cone 3B, Slider Sleeve 7B of Driven Cone 5B, Adjuster 8.

A CVT 6 comprises of two substantially identical CVT 4's. The basic configuration of a CVT 4 is described U.S. patent application Ser. No. 13/629,613. Here one CVT 4 is referred to as CVT 4A, and the other CVT 4 is referred to as CVT 4B. The driving cones (which each are a cone with one torque transmitting member and which preferably have the same dimensions) of CVT 4A and CVT 4B are mounted on a common shaft/spline through a slider sleeve each (which allow axial but not rotational movements relative to its shaft/spline) in manner so that the larger end of one cone is facing the smaller end of the other cone; and the driven cones (which each are also a cone with one torque transmitting member and which also preferably have the same dimensions) of CVT 4A and CVT 4B are also mounted on a common shaft/spline through a slider sleeve each (which allow axial but not rotational movements relative to its shaft/spline) in manner so that the larger end of one cone is facing the smaller end of the other cone. It is recommended that the axial positions of the driving cones can be changed independent of each other, and that the axial positions of the driven cones can also be changed independent of each other.

For each CVT 4 (CVT 4A and CVT 4B), one of their cones is mounted on its slider sleeve through the use of an adjuster (labeled as adjuster 8 in FIG. 5) that can: a) provide rotational adjustment between its cone and the shaft/spline on which it is mounted when needed; and b) prevent any rotational movements between its cone and the shaft/spline on which it is mounted when needed. The adjuster that uses a gear that is driven by a worm gear, described in U.S. Pat. No. 7,722,490 B2 and U.S. patent application Ser. No. 11/978,456 can be used as the adjusters; and here a cone can be mounted on its shaft/spline through the use of an adjuster and a slider sleeve in a similar manner as a transmission pulley of a CVT 2 is mounted on its shaft/spline through the use of an adjuster and a slider sleeve (see U.S. Pat. No. 7,722,490 B2).

If a cone is mounted through an adjuster, the rotational position sensor that is used to determine the rotational position of that cone needs to be mounted on that cone or a portion that rotates with that cone. The rotational position sensor of a cone is needed to determine/estimate the rotational position of the torque transmitting member of said cone, which is needed to know when to change the axial position of a cone (see U.S. patent application Ser. No. 13/889,049).

### Reducing Tension in a Transmission Belt of a CVT 6

A CVT 6 can be operated so that the tension in the transmission belt of one CVT 4 can be reduced when desired through the use of the adjusters 8. Here for the CVT 4 for which the tension in the transmission belt is to be reduced, the adjuster 8 for that CVT 4 rotates its cone relative to its shaft/spline so as to provide a releasing torque, while the adjuster 8 of the other CVT 4 is locked/braked (or provides a slower rotating releasing torque) so that full torque transfer between its cone and its shaft/spline occurs. If the shaft/spline on which an adjuster is mounted is the input shaft, than the direction of rotation of its cone for a releasing torque is the direction opposite from the rotation of the input shaft/spline. And if the shaft/spline on which an adjuster is mounted is the output shaft, than the direction of rotation of its cone for a releasing torque is the direction of rotation of the output shaft/spline.

The duration that a releasing torque is provided by an adjuster before axial position changing of its cone is started can be based on a “set time duration”. The ideal “set time duration” can be obtained through experimentation. For example, let's say we select the “set time duration” to be 1 second; here if this duration is sufficient for the adjuster to sufficiently reduce the tension in the transmission belt for all operating conditions/situations, than 1 second can be used as the “set time duration” for that adjuster, or if desired further experiments can be performed in order to obtain a smaller “set time duration”; and if 1 second does not allow the adjuster to sufficiently reduce the tension in the transmission belt for all driving conditions, than additional experiment(s) with larger than 1 second “set time duration(s)” need to be performed until a “set time duration” that allows the adjuster to sufficiently reduce the tension in the transmission belt for all driving conditions is obtained.

When the “set time duration” has expired, axial position changing of said cone can be started. After the “set time duration” has expired, the adjuster 8 stops providing a releasing torque and is stopped/locked or used for other purposes. Here proper coordination can be performed by a controlling computer that controls the axial position changing of said cone, and the adjuster 8 that provides the releasing torque. Instead of a “set time duration”, torque sensor(s) can also be used to determine when the tension in a transmission belt is sufficiently reduced so that axial position changing of a cone can be started.

When providing a releasing torque an adjuster 8 can eventually stall or slip. Here it is recommended that the torque of the adjuster 8 is limited so that it will be enough to release the tension in the pulling side of the transmission belt of its cone, but not large enough to significantly increase the tension in the slack side of the transmission belt.

For an adjuster that uses a motor that rotates a worm gear that is coupled to a gear, letting an adjuster slip can be accomplished by placing a slipping clutch between the output shaft of the adjuster and the worm gear. This way the locking ability of the worm gear-gear drive is not compromised. See U.S. Pat. No. 7,722,490 B2 for more details regarding this.

If no slippage between a cone and its transmission belt is allowed, then changing the axial position of a cone relative to its transmission belt can rotate a cone. This type of rotation is referred to as “Transmission ratio change rotation” in U.S. Pat. No. 7,722,490 B2. “Transmission ratio change rotation” has to be allowed or compensated for during axial position change of a cone relative to its transmission belt, otherwise large tension in the transmission belt can develop.

Furthermore, for a worm gear-gear drive of an adjuster 8, it is recommended that the difference between the worm locking force and worm rotating force is not much greater than the difference required to ensure reliable locking when needed. This way the torque required to unlock the worm gear-gear drive can be kept as small as practical.

If desired other type of adjusters can be used for the adjusters 8, such as an adjuster that uses a worm gear-gear drive that uses a worm gear brake so that its worm gear-gear drive can be made locking or non-locking. Or an adjuster that uses a main gear that is identical to the gear of a worm gear-gear drive that is than coupled directly or through other spur gears to a braking gear (which has more speed but less torque than said main gear) that can be braked as needed. Many other design for an adjuster 8 are also possible.

### Compensating/Allowing for “Transmission Ratio Change Rotation” in a CVT 6

For a CVT 6 the cones are prevented from freely rotating to compensate for “Transmission ratio change rotation”, since two cones that cannot freely rotate relative to each other are mounted on a common shaft/spline and the transmission ratio (axial position of a cone relative to its transmission belt) of the cones on said common spline are changed independent of each other. As such the adjuster(s) 8 also need to be used to compensate/allow for “Transmission ratio change rotation”.

For a cone mounted on an adjuster 8, in order to compensate/allow for “Transmission ratio change rotation” of said cone, said cone mounted on an adjuster 8 needs to be rotated by its adjuster 8 in the direction of the “Transmission ratio change rotation” of said cone during axial position change of said cone relative to its transmission belt, so that said cone can rotate relative to its spline in the direction of its “Transmission ratio change rotation”. It is recommended that here adjuster 8 rotates its said cone faster than required; the excess speed of the adjuster 8 will only cause the adjuster 8 to stall or slip.

For a non-adjuster mounted cone, in order to compensate/allow for “Transmission ratio change rotation” of said non-adjuster mounted cone, the adjuster mounted cone to which said non-adjuster mounted cone is coupled and which is mounted on an adjuster 8, needs to be rotated by adjuster 8 in the direction opposite of the direction of rotation of the “Transmission ratio change rotation” of said non-adjuster mounted cone during axial position change of said non-adjuster mounted cone relative to its transmission belt. This is performed so as to provide or remove slack as needed in the tense side and slack side of the transmission belt of said non-adjuster mounted cone. It is recommended that here adjuster 8 rotates its cone faster than required; the excess speed of the adjuster 8 will only cause the adjuster 8 to stall or slip.

The explanations of the previous two paragraphs should be correct. In order to be entirely sure this is the case, or in order to determine the correct direction(s) of rotation if this is not the case, experimentation can be performed. There are only two possible directions of rotation, so the experiments will be very simple.

When an adjuster 8 is used to compensate/allow for of “Transmission ratio change rotation”, it is recommended that the adjuster 8 starts to provide adjustment slightly before adjustment to compensate/allow for of “Transmission ratio change rotation” is required. Since it is better to have the adjuster 8 unlocked to compensate/allow for of “Transmission ratio change rotation” earlier, than later (where uncompensated “Transmission ratio change rotation” can cause large stresses in the transmission belt and prevent a cone from moving axially).

The direction of “Transmission ratio change rotation” of a cone can depend on the configuration of the CVT 4's of the CVT 6, the axial movement of said cone (“increasing transmission diameter change of said cone” or “decreasing transmission diameter change of said cone”), and the rotational position of said cone. Here the direction of “Transmission ratio change rotation” of a cone for all possible cases can be easily determined through experimentation (there are only two possible directions for all cases).

An experiment to determine the direction of “Transmission ratio change rotation” of the cone(s) of a CVT 6 can be made by using a Test CVT. A Test CVT can be a CVT 6 for which the cones are mounted so that they can each be set to either “freely rotate relative to the shaft/spline on which they are mounted” or “locked relative to the shaft/spline on which they are mounted”. Here “Transmission ratio change rotation” of a cone for a given axial movement and a given rotational position can be easily be observed by first allowing said cone to “freely rotate relative to the shaft/spline on which it is mounted” while keeping all other cones “locked relative to the shaft/spline on which they are mounted”, and then changing the axial position of said cone and observing the rotation due to it. By using this procedure repeatedly, the “Transmission ratio change rotation” for all axial movements and all rotational positions of a cone can be determined for all cones.

In some instances, the direction of rotation of “Transmission ratio change rotation” of a cone depends on the rotational position of said cone relative to its transmission belt. If so, this depends on where the neutral point (referred to as Point N) is positioned relative to the Point M of its cone. Point N is the contact point between a cone and its transmission belt that doesn't substantially rotate/move due to changes in the transmission diameter of said cone. Point M of a cone is the point were no rotational sliding between said cone and its torque transmitting member occur due to axial position change of said torque transmitting member relative to said cone. See U.S. Pat. No. 7,722,490 B2 for detailed explanation regarding this.

Here experimentation using the Test CVT of the previous paragraph can be used to determine the direction of rotation of “Transmission ratio change rotation” of a cone for the different relative rotational positions of said cone, such as “Point N positioned behind Point M”, and Point N positioned ahead of Point M”.

If the direction of rotation of “Transmission ratio change rotation” of a cone depends on the rotational position of said cone relative to its transmission belt and only one adjuster 8 is used to compensate for “Transmission ratio change rotation”, then the duration at which the axial position of a cone can be changed needs to be shorten so that it is not longer than the longest duration at which the direction of rotation of “Transmission ratio change rotation” of said cone is in one direction.

If two adjusters 8 are used to compensate for “Transmission ratio change rotation” of a cone, the axial position of said cone can be changed during an interval where changes in the direction of rotation of “Transmission ratio change rotation” of said cone occur.

One method to allow axial position change of a cone during an interval where changes in the direction of rotation of “Transmission ratio change rotation” of said cone occur, is by having both adjusters 8 of the cones that are mounted on the same spline/shaft rotate in the same direction (preferably faster than required) during axial position change of one of said cones or a cone to which said cones are coupled. This allows/compensates for clockwise and counter-clockwise “Transmission ratio change rotation” of the cone which axial position is changed, since here one adjusters 8 allows/compensates for “Transmission ratio change rotation” in one direction and the other adjusters 8 allows/compensates for “Transmission ratio change rotation” in the other direction. The torque of the adjusters 8 should be limited so that they can only allow but not able to resist “Transmission ratio change rotation”. In order to ensure that the tension in the transmission belt of the cone which axial position is changed remains low, the adjuster 8 of the cone used for torque transmission should rotate the opposite direction of a releasing torque (a releasing torque is a torque that releases the tension in its transmission belt). This method is referred to as the “Active adjusters on the same shaft method”.

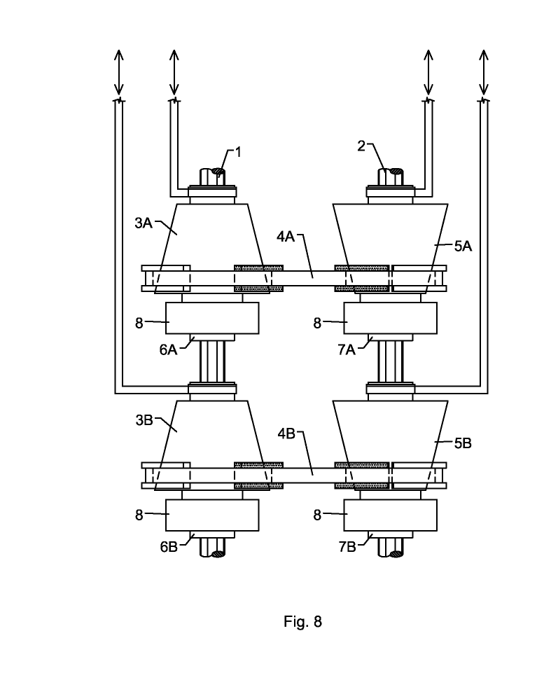

Another method to allow axial position change of a cone during an interval where changes in the direction of rotation of “Transmission ratio change rotation” of said cone occur, is by using a configuration of a CVT 6 where all cones are mounted on an adjuster (see FIG. 8), and for the CVT 4 for which the axial position of a cone is changed, having the adjusters 8 of the cone on the input shaft and the adjuster 8 of the cone on the output shaft rotate in the same direction during axial position change of said cone. Here one adjusters 8 allows/compensates for “Transmission ratio change rotation” in one direction and the other adjusters 8 allows/compensates for “Transmission ratio change rotation” in the other direction. The torque of the adjusters 8 should be limited so that they only allow but are not able to resist “Transmission ratio change rotation”. For this method the direction of rotation of the adjusters 8 should be in the direction such that at least one cone of the CVT 4 for which the axial position of a cone is changed is rotated in the direction “the cone needs to rotate” or “the cone will need to rotate after its axial position is changed” due to having cones of different diameters mounted on the same shaft; here the adjusters 8 can simply stall or slip when their rotation are not needed. This method is referred to as the “Active adjusters on the same CVT method”.

For the “Active adjusters on the same CVT method”, if both adjusters 8 of a CVT 4 are rotated in the direction opposite of the direction their CVT 6 is rotating during axial position change of a cone of said CVT 4, it needs to be ensured that the cone which axial position is changed does not rotate in the opposite direction its CVT 6 is rotating under all transmission ratio changing operating conditions of its CVT, since this might cause the torque transmitting member of said cone to re-engage with the portion of the transmission belt it just disengaged. This can be ensured by limiting the speed and/or the torque of the adjusters 8.

For the “Active adjusters on the same shaft method”, under certain situations (such as low speed and high torque situations), the tension in the transmission belt for which the tension was reduced and for which the axial position of its cone(s) is changed, can significantly increase due to “Transmission ratio change rotation”. Unless it can be ensure that this is not happening under all operating conditions of the CVT 6, the “Active adjusters on the same CVT method” is preferred since otherwise there is no advantage in reducing the tension in a transmission belt. Unlike the “Active adjusters on the same shaft method”, for the “Active adjusters on the same CVT method” no rotation of the input shaft/spline or output shaft/spline due to “Transmission ratio change rotation” is required. When rotation of the input shaft/spline or output shaft/spline due to “Transmission ratio change rotation” is required, large resistance to rotation of the input shaft/spline or the output shaft/spline can significantly increase the tension in the transmission belt which tension was reduced.

The required and torque and speed of an adjuster 8 can easily be obtained through trial-and-error and experimentation. “Transmission ratio change rotation” can be attributed to: a) “belt curvature change rotation”, which is rotation due to movement of the slack side and/or tense side of the transmission belt relative to its cone in order to provide/remove slack due to changes in the transmission diameter of its cone; and b) “member curvature change rotation”, which is rotation due to changes in the curvature of the torque transmitting member of the cone which axial position is changed. If the axial position of a cone is changed so that the transmission circumference of its cone increases or decreases by an arc length of one full tooth for all axial position changing steps, then the maximum “belt curvature change rotation” for all axial position changing steps is one full tooth and the maximum “member curvature change rotation” for all axial position changing steps is also one full tooth. As such the maximum “Transmission ratio change rotation”, which is due to “belt curvature change rotation” and “member curvature change rotation” is two teeth.

The angular distance of two teeth depends on the total amount of teeth width of the transmission circumference. If the transmission circumference of a cone is 20 teeth, then the angular distance of two teeth is 2/20 times 360 deg. This angular distance has to be covered during the axial position changing interval of said cone. From this theory, a ball park estimate for the required rotational speed and angular acceleration of the adjusters 8 for the most demanding operating condition (which should occur when the axial position changing interval duration of a cone is shortest & and the transmission circumference of a cone is smallest) of the CVT 6 can be obtained. This ball park estimate and trial-and-error experimentation can then be used to obtain the actual minimum required rotational speed and angular acceleration of the adjusters 8 that allows for axial position change of all cones without interruption due to “Transmission ratio change rotation” for all operating conditions of the CVT 6.

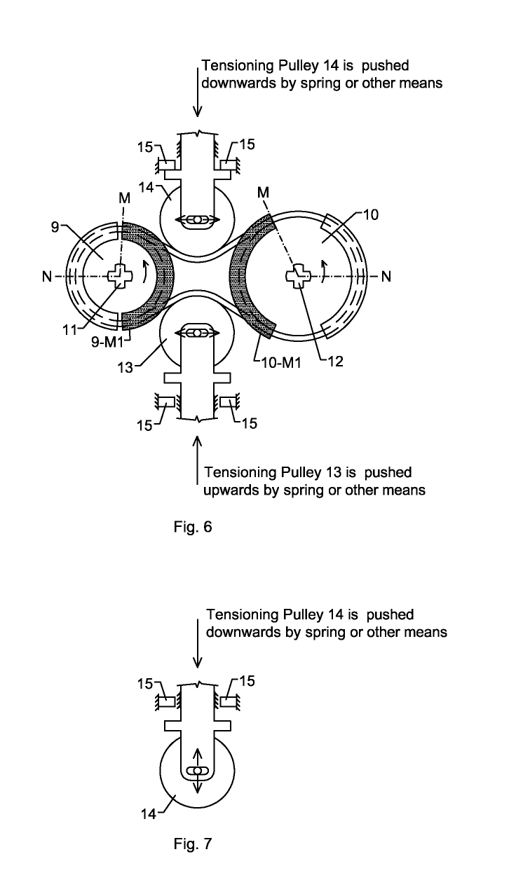

“Transmission ratio change rotation” due to “belt curvature change rotation” in the slack side portion of the transmission belt can also be compensated by having the tensioning pulley/support pulley on the slack side of the transmission belt provide and remove slack in the slack side of the transmission belt as needed in order to compensate for “Transmission ratio change rotation” due to “belt curvature change rotation” in the slack side of the transmission belt. A tensioning pulley/support pulley on the slack side of the transmission belt is shown in FIG. 6 where it is labeled as Tensioning Pulley 13.

If a tensioning pulley/support pulley on the slack side of the transmission belt is used to compensate for “Transmission ratio change rotation” due to “belt curvature change rotation” in the slack side of the transmission belt, then the adjusters 8 of a CVT 4 do not need to provide slack in the slack side of the transmission belt to compensate for “Transmission ratio change rotation” due to “belt curvature change rotation” in the slack side of the transmission belt; so that both adjusters 8 of the CVT 4 can be rotated in the directions that increase slack in the tense side of the transmission belt if allowed by “Transmission ratio change rotation due to “member curvature change rotation” or if “Transmission ratio change rotation due to “member curvature change rotation” compensated/allowed using other means.

If desired a tensioning pulley/support pulley on the tense side of the transmission belt that provides and removes slack in the tense side of the transmission belt as needed in order to compensate for “Transmission ratio change rotation” “due to “belt curvature change rotation” in the tense side of the transmission belt can also be used.

Unlike the slack side tensioning pulley/support pulley which needs to provide and remove slack during all operating conditions, the tense side tensioning pulley/support pulley can be designed so that it only provides and removes slack when the tension in the transmission belt has been reduced. As such, here a maximum contraction stop, which engages with the tense side tensioning pulley/support pulley and stops the movement of the tense side tensioning pulley/support pulley when the tension in the transmission belt is not reduced, can be used. Here once the tension in the transmission belt has been reduced, the tense side tensioning pulley/support pulley is pushed away from its maximum contraction stop by its tensioning force, which can be provided by spring(s), weight(s), etcetera; and this should give the tense side tensioning pulley/support pulley a “contracting and extending movements range” that can be used to provide and remove slack when required. Here the contracting movements range allow the tense side tensioning pulley/support pulley to move away from its transmission belt, and the extending movements range allow the tense side tensioning pulley/support pulley to move towards from its transmission belt.

A front-view of a CVT 4 that uses slack side tensioning pulley/support pulley and a tense side tensioning pulley/support pulley is shown in FIG. 6. In FIG. 6, the slack side tensioning pulley/support pulley is labeled tensioning pulley 13, and the tense side tensioning pulley/support pulley is labeled tensioning pulley 14. Tensioning pulley 14 is also shown in FIG. 7. In FIG. 6, tensioning pulley 14 is engaged with its maximum contraction stop 15 since the tension in its transmission belt has not been reduced. In FIG. 7, tensioning pulley 14 is not engaged with its maximum contraction stop 15 since the tension in its transmission belt has been reduced. Also shown in FIG. 7 are the directions of the contracting and extending movements of tensioning pulley 14. Tensioning pulley 13 can have the same directions; but this is not a requirement, since the directions of the contracting and extending movements of the tensioning pulleys can be any directions that can remove and provide transmission belt slack.

It is also recommended that the slack side tensioning pulley/support pulley (labeled as tensioning pulley 13 in FIG. 6) also has a maximum contraction stop 15. Here the maximum contraction stop can be used to prevent excessive contracting movement of the slack side tensioning pulley/support pulley due to increase in tension in the slack side of its transmission belt, which can be due to a releasing torque provide by its adjuster(s) 8 or due to rotations of its cone(s) due to having to compensate for having cones of different diameters mounted on the same shaft.

If both a slack side tensioning pulley/support pulley and a tense side tensioning pulley/support pulley are used, the tensioning forces of the pulleys should be balanced such that when the tension in the transmission belt has been reduced, both pulleys are positioned so that they have a sufficient “contracting and extending movement range” to provide and remove slack as needed to compensate for “Transmission ratio change rotation”, to accommodate for the transmission diameter change of a cone, and to compensate for having cones of different diameters mounted on the same shaft during axial position changing of a cone. Here it is preferred that the tensioning forces of the pulleys are provided by springs, since here slightly unbalanced tensioning forces of the pulleys can be balanced/equaled by slight movements of the pulleys. The required “contracting and extending movement ranges” of the pulleys can be obtained through “trial and error” experimentation; as a conservative ball park figure that can be refined through “trial and error” experimentation, a movement range that allows for 3 teeth rotation of a cone in both directions can be used. Also here the axial position of a cone should only be changed after the slack side tensioning pulley/support pulley and the tense side tensioning pulley/support pulley have reached their balanced position.

If both a slack side tensioning pulley/support pulley and a tense side tensioning pulley/support pulley are used, then the contracting and extending movements of the pulleys can allow for limited rotation of a cone. If said limited rotation of a cone is sufficient to compensate for “Transmission ratio change rotation”, then the adjusters 8 are not needed to compensate/allow for “Transmission ratio change rotation”.

For the preferred CVT 6, the axial positions of the cones of a CVT 6 are changed in manner such that when there are “cones with different transmission diameters mounted on a same shaft/spline”, the next axial position change of a cone is always such that the transmission diameters of said “cones with different transmission diameters mounted on a same shaft/spline” are equal. Therefore, since during regular operations (non-“transmission ratio changing” operations) of a preferred CVT 6 the transmission diameters of all cones mounted on the same shaft/spline are equal, there should be only one shaft/spline at a time for which there are “cones with different transmission diameters mounted on a same shaft/spline”.

For the preferred CVT 6, when there are no “cones with different transmission diameters mounted on the same shaft/spline”, before the axial position of a cone (referred to as the moved cone) is changed, one adjuster 8 of a cone (referred to as the rotated cone) needs to “rotate preferably faster than required” or “have its worm gear-gear drive unlocked” in the direction “the rotated cone will need to rotate in order to “compensate for having cones with different transmission diameters mounted on the same shaft” after the axial position of the moved cone is changed”; here said adjuster 8 can simply stall or slip when its rotation is “not” or “not yet” needed. It is recommended that here the rotated cone is only “rotated” or “allowed to rotate” in the direction that increases the tension in the tense side of its transmission belt; the selection of whether the rotated cone is a cone that is coupled to the transmission belt which tension was reduced, or a cone that is coupled to the transmission belt which tension was not reduced should depend only on this. Since here if the tension in the transmission belt of the “CVT 4 with which the CVT 4 of the rotated cone is alternately used to transfer torque” is reduced by using one of its adjuster 8 to “compensate for having cones with different transmission diameters mounted on the same shaft”, the rotated cone can be slowed-down and eventually locked by its adjuster 8. This prevents having adjusters 8 of both CVT 4's become unlocked, which is undesirable since relocking an adjuster 8 under load can require a large torque. Also here the moved cone and the rotated cone can be or cannot be the same cone, depending on the situation.

Regarding the previous paragraph, for the preferred CVT 6, when there are no “cones with different transmission diameters mounted on the same shaft/spline”, before axial position changing of a cone and until relived by an adjuster 8 of the other CVT 4 or until its rotation is not needed anymore due to a subsequent “axial position changing of a cone” that equalize the transmission diameters of all cones mounted on the same shaft, the direction that an adjuster 8 rotates its cone in order to “compensate for having cones with different transmission diameters mounted on the same shaft” is in the direction that increases the tension in the tense side of its transmission belt. Here for two cones mounted on a common input shaft, the smaller cone needs to be “rotated” or “allowed to rotate” in the direction said common input shaft is rotating; or a cone that is mounted on an output shaft and that is coupled to said smaller cone, needs to be “rotated” or “allowed to rotate” in the opposite direction said output shaft is rotating (here it is assumed that the transmission diameters of the cones mounted said output shaft are identical). And here for two cones mounted on a common output shaft, the larger cone needs to be “rotated” or “allowed to rotate” in the opposite direction said common output shaft is rotating; or a cone that is mounted on an input shaft and that is coupled to said larger cone, needs to be “rotated” or “allowed to rotate” in the direction said input shaft is rotating (here it is assumed that the transmission diameters of the cones mounted said input shaft are identical).

For the preferred CVT 6, when there are “cones with different transmission diameters mounted on the same shaft/spline”, before and during axial position changing of a cone, the cone that is used to “compensate for having cones with different transmission diameters mounted on the same shaft” can be rotated by its adjuster 8 in either directions as convenient, here said adjuster 8 can simply stall or slip when its rotation is not needed; since here after said axial position changing of a cone, the transmission diameters of the cones mounted on said same shaft/spline should be equal. So that here said adjuster 8 can simply be stopped once there is no need to “compensate for having cones with different transmission diameters mounted on the same shaft”.

Regarding the previous paragraph, for the preferred CVT 6, when there are “cones with different transmission diameters mounted on the same shaft/spline”, in order to the release tension in its transmission belt and to “compensate for having cones with different transmission diameters mounted on the same shaft”, a larger cone mounted on the input shaft/spline can simply be rotated in the opposite direction its said input shaft/spline is rotating; or smaller cone mounted on the output shaft/spline can simply be rotated in the direction its said output shaft/spline is rotating. And in order to maintain the released tension in its transmission belt and to “compensate for having cones with different transmission diameters mounted on the same shaft”, a smaller cone mounted on the input shaft/spline can simply be rotated in the direction its said input shaft/spline is rotating; or larger cone mounted on the output shaft/spline can simply be rotated in the opposite direction its said output shaft/spline is rotating.

During axial position changing of a cone, in order to prevent an increase in tension in the transmission belt for which the tension was reduced (which should be the transmission belt of the cone which axial position is changed) due to changes in the transmission diameter of the cone which axial position is changed (increasing transmission diameter for a cone mounted on the input shaft and decreasing transmission diameter for a cone mounted on the output shaft), the contracting and extending movements of the slack side tensioning pulley/support pulley and the tense side tensioning pulley/support pulley should be able to “compensate for having cones with different transmission diameters mounted on the same shaft”. Here it is not required that only the contracting and extending movements of the tensioning pulleys are used to “compensate for having cones with different transmission diameters mounted on the same shaft”; however, here it is required that the ability of the contracting and extending movements of the tensioning pulleys to “compensate for having cones with different transmission diameters mounted on the same shaft” has not been exhausted. When the axial positions of a cone is changed such that its circumference is increased or decreased by one tooth during an axial position changing interval; then during one full rotation of the cone, the maximum amount of rotation needed to compensate for having cones with different transmission diameters mounted on the same shaft is “one tooth” or “slightly more than one tooth”, so this should be feasible.

The tension in the transmission belt of a CVT 4 for which the transmission belt tension was reduced can be increased by rotating a cone of the other CVT 4 in the direction that reduces its transmission belt tension, and if necessary slowing-down and eventually locking all cones of said CVT 4 for which the transmission belt tension was reduced. Increasing the tension in the transmission belt of one CVT 4 reduces the tension in the transmission belt of the other CVT 4. For example, for an input shaft on which a smaller cone (smaller transmission diameter cone) and larger cone (larger transmission diameter cone) are mounted; when said smaller cone is currently rotated by its adjuster 8 in the direction said input shaft is rotating in order “compensate for having cones with different transmission diameters mounted on the same shaft”, then the tension of the transmission belt of said larger cone can be reduced by rotating said larger cone in the opposite direction said input shaft is rotating in order “compensate for having cones with different transmission diameters mounted on the same shaft” and slowing-down and eventually locking the adjuster 8 of said smaller cone.

Changing the axial position of a cone can also increase the tension in the transmission belt for which the tension was reduced. Examples of this is when the transmission diameter of a cone mounted on the input shaft is increased and the rotation provided by the contracting and extending movements of the slack side tensioning pulley/support pulley and the tense side tensioning pulley/support pulley has been exhausted; and when the transmission diameter of a cone mounted on the output shaft is decreased and the rotation provided by the contracting and extending movements of the slack side tensioning pulley/support pulley and the tense side tensioning pulley/support pulley has been exhausted. It is recommended that this only occurs after axial position of a cone has been changed, since otherwise there might be little benefit in reducing the tension in a transmission belt in order to reduce the force needed to change the axial position of a cone.

By using the methods of the previous paragraphs to allow/compensate for “Transmission ratio change rotation”, the need to accurately determine the direction(s) of “Transmission ratio change rotation” become unnecessary.

### Transmission Ratio Changing Procedure for Reducing the Torque Requirements of the Adjusters of a CVT 6

In this section, a “preferred transmission ratio changing procedure for a CVT 6” that can be used to reduce the torque requirements of the adjusters (adjusters 8) of a preferred CVT 6 is described. Using the “preferred transmission ratio changing procedure for a CVT 6”, the torque requirements of the adjuster motors can be reduced to a level where the adjuster motors only need sufficient torque to unlock their worm gear-gear drives (the worm gear-gear drives of their adjusters) when needed and sufficient torque (braking torque if necessary) to relock their worm gear-gear drives when they are “slowing-down and about to change their direction of rotation”. Here during relocking, the adjuster motors are assisted by the “static locking friction” of their worm gear-gear drives, and during unlocking the adjuster motors need to overcome the “static locking friction” of their worm gear-gear drives.

When an adjuster needs to remain unlocked, its adjuster motor needs to keep rotating the worm gear of the worm gear-gear drive of the adjuster in the direction that rotates the adjuster output shaft in the direction that the adjuster needs to be allowed to rotate. In some instances stalling/slipping of an adjuster motor might occur because its adjustment is “not yet required” or “at that instance not required”.

The torque of an adjuster motor should be large enough so that it can accelerate fast enough when adjustment is suddenly required after an instance where it was not, so as to prevent any potential damage in its CVT 6. Here trial and error experimentation and/or engineering can be used. Furthermore, an adjuster motor should also be able to rotate at a sufficient speed to keep its worm gear-gear drive unlocked; the speed to keep a worm gear-gear drive unlocked is a speed where the “kinetic locking friction” of the worm gear-gear drive is less than the rotational force applied to its adjuster output shaft.

An unlocked adjuster should allow rotation at the speed required even when the “speed its adjuster motor rotates its adjuster output shaft” is less than the “speed applied on its adjuster output shaft (such as due to transmission ratio change rotation, having cones of different diameters mounted on the same shaft, etc.)”.

When an adjuster is unlocked but “the speed its adjuster motor rotates its adjuster output shaft” is less than “the speed applied on its adjuster output shaft”, then an increase in tension in the slack side or tense side of the transmission belt of its CVT 4 can occur; this is due to the pulling tension required to rotate the unlocked adjuster output shaft. If this causes problems, the tension of the tensioning pulleys/support pulleys of its CVT 4 can be increased; or the speed of its adjuster motor can be increased so that the “speed its adjuster motor rotates its adjuster output shaft” is equal to or more than the “speed applied on its adjuster output shaft”. Or, if desired an external motor (which avoids the speed reduction gearing of the worm gear-gear drive of the adjuster) can be used to rotate the cone of an adjuster as required.

Instead of using an adjuster motor to controllably lock and unlock an adjuster, a friction brake can be used. Here when an adjuster needs to be locked, the friction brake applies braking friction to the worm gear of the worm gear-gear drive; and when an adjuster needs to be unlocked, the friction brake does not apply braking friction to the worm gear of the worm gear-gear drive. If desired, a friction brake can also be used in conjunction with an adjuster motor to controllably lock and unlock an adjuster.

Alternately an adjuster can also be designed so that the “kinetic locking friction” of its worm gear-gear drive is never less than the rotational force applied to its adjuster output shaft. Since here the adjuster will not allow free rotation at any speed required, its adjuster motor needs to be able rotate its adjuster output shaft at the speed required or faster.

Said preferred CVT 6 (a CVT 6 is a CVT that uses two substantially identical CVT 4's, see FIG. 5 for an example) is a CVT 6 that uses one adjuster for each CVT 4 (it doesn't matter of which shaft/spline of their CVT 4 the adjusters are mounted); and a CVT 6 for which each CVT 4 has both a slack side tensioning pulley/support pulley and a tense side tensioning pulley/support pulley (see FIG. 6). The slack side tensioning pulleys/support pulleys and the tense side tensioning pulleys/support pulleys have sufficient (preferably slightly more, to prevent exhaustion of their ability to provide and remove slack during axial position changing of a cone of their CVT) “contracting and extending movement ranges” to provide and remove slack as needed to allow for axial position changing of a cone of their CVT for all operating conditions of their CVT even when no adjuster is active, by “compensating for Transmission ratio change rotation, by accommodating for the transmission diameter change of a cone, and/or “by compensating for having cones of different transmission diameters mounted on the same shaft” during axial position changing of a cone of their CVT.

Unlike a slack side tensioning pulley/support pulley (labeled as 13 in FIG. 6), which needs to be able to provide and remove slack during all operating conditions of its CVT when needed, a tense side tensioning pulley/support pulley (labeled as 14 in FIG. 6) can be designed such that it can only provide and remove slack when the tension in its transmission belt has been reduced. As such, here a maximum contraction stop (labeled as 15 in FIG. 6), which engages with the tense side tensioning pulley/support pulley (labeled as 14 in FIG. 6) and stops the movement of the tense side tensioning pulley/support pulley when the tension in the transmission belt is not reduced, can be used. Here once the tension in the transmission belt has been reduced, the tense side tensioning pulley/support pulley should be pushed away from its maximum contraction stop by its tensioning force (as shown in FIG. 7); and this should give the tense side tensioning pulley/support pulley a “contracting and extending movements range” that can be used to provide and remove slack when required.

It is recommended that both the slack side tensioning pulley/support pulley and the tense side tensioning pulley/support pulley have each a “maximum contraction stop”. The “maximum contraction stops” should be used to limit the movements of the tensioning pulleys/support pulleys to a range that allows for proper operation.

It is recommended that the tensioning forces of the tensioning pulleys/support pulleys are provided by compression springs, which extending forces increase as they are compressed more. Since here slightly unbalanced tensioning forces of the tensioning pulleys/support pulleys can be balanced/equaled by slight movements of the tensioning pulleys/support pulleys. For example, after the tension in their transmission belt has been reduced, when the spring of the tense side tensioning pulley/support pulley is more compressed than the spring of the slack side tensioning pulley/support pulley, then the larger compression force of the spring of the tense side tensioning pulley/support pulley can reduce the compression in the spring of the tense side tensioning pulley/support pulley and increase the compression in the spring of the slack side tensioning pulley/support pulley until the tensioning pulleys/support pulleys have reached their equilibrium position. Using tensioning springs or other tensioners for which their transmission belt tensioning force increase as their “available contraction distance” is reduced can also be used. The “available contraction distance” of a tensioning pulley/support pulley determines the amount of slack that can be provided by that tensioning pulley/support pulley when needed.

In general (there might be exceptions for items d) and e) of the “preferred transmission ratio change procedure for a CVT 6” shown below), the stiffness of the tensioners of the tensioning pulleys/support pulleys, and the parameters (torque, speed, unlocked frictional resistance) of the adjusters should be selected so that when the tension in their transmission belt has been reduced, the tense side tensioning pulley/support pulley and the slack side tensioning pulley/support pulley should each have a sufficient “contracting and extending movement range” to provide and remove slack as needed to allow for axial position changing of a cone for all operating conditions of their CVT by “compensating for Transmission ratio change rotation, by “accommodating for the transmission diameter change of a cone”, and/or by “compensating for having cones of different transmission diameters mounted on the same shaft” during axial position changing of their cone. Here when the tension in their transmission belt has been reduced, the tense side tensioning pulley/support pulley and the slack side tensioning pulley/support pulley should each have a said sufficient “contracting and extending movement range” when their adjuster is activated to rotate clockwise and counter-clockwise (regardless of whether the adjuster is stalling, rotating and applying a torque on said transmission belt, or unlocked), and when their adjuster is not active. Here trial and error experimentation and/or engineering can be used.

In order to move vertically as required, the tensioning pulleys/support pulleys can each be mounted on a spring loaded vertical slider. A spring loaded vertical slider comprises of a vertical slider that allows for sufficient vertical movements as required, and a spring that provides sufficient tensioning forces as required. If the tensioning pulleys/support pulleys are also to be allowed to move horizontally, the spring loaded vertical sliders can each be mounted on a horizontal sliders; or the spring loaded vertical sliders can each have slotted holes into which the shafts of tensioning pulleys/support pulleys are inserted and fastened using bolts or locking rings, as partially shown in FIG. 6.

Furthermore, the tensioning forces of the tensioning pulley/support pulleys should not be large enough so that they can prevent axial position changing of a cone.

The “preferred transmission ratio change procedure for a CVT 6” is described in the paragraphs below.

### a) Initial Setup/Regular Operation Setup

Before a transmission ratio changing procedure is started, the transmission diameters of all cones mounted on the same shaft/spline (such as the input spline and output spline) are equal.

### b) Reducing Transmission Belt Tension

Next, if required, the tension in the transmission belt of the CVT 4 for which the axial position of a cone is to be changed is reduced. Here the adjuster for that CVT 4 rotates its cone relative to its shaft/spline so as to provide a releasing torque, while the adjuster of the other CVT 4 is locked/braked or provides a slower rotating releasing torque so that full torque transfer between its cone and its shaft/spline occurs.

Once the tension in the transmission belt of “the CVT 4 for which the axial position of a cone is to be changed” has been sufficiently reduced (which can be based on “a set time duration required to achieve this” or “a torque sensor”), the adjuster used to reduce the tension in the transmission belt of “the CVT 4 for which the axial position of a cone is to be changed” is stopped/locked.

If the shaft/spline on which an adjuster is mounted is the input shaft, than the direction of rotation of its cone for a releasing torque is the direction opposite from the rotation of the input shaft/spline. And if the shaft/spline on which an adjuster is mounted is the output shaft, than the direction of rotation of its cone for a releasing torque is the direction of rotation of the output shaft/spline.

### c) First Axial Position Changing of a Cone

It is recommended that this step is initiated immediately after an adjuster has stopped providing a releasing torque in order to avoid changes in the “contracting and extending movement ranges” of the tensioning pulleys/support pulleys for which the tension in their transmission belt has been reduced due to slight differences in the transmission diameters of the cones mounted on same shaft/spline or any other factors.

Before the axial position of a cone (referred to as the moved cone) is changed, one adjuster of a cone (referred to as the rotated cone) needs to “rotate preferably faster than required” or “have its worm gear-gear drive unlocked” in the direction “the rotated cone will need to rotate in order to “compensate for having cones with different transmission diameters mounted on the same shaft” after the axial position of the moved cone is changed”; here said adjuster can simply stall or slip when its rotation is “not” or “not yet” needed. Here the rotated cone is only “rotated” or “allowed to rotate” in the direction that increases the tension in the tense side of its transmission belt; the selection of whether the rotated cone is a cone that is coupled to the transmission belt which tension was reduced, or a cone that is coupled to the transmission belt which tension was not reduced should depend only on this.

Regarding the rotated cone, the CVT 4 for which a cone (the rotated cone) has to be rotated in the direction that increases the tension in the tense side of its transmission belt in order to “compensate for having cones with different transmission diameters mounted on the same shaft” is a CVT 4 for which its cone on the input shaft/spline has the smaller transmission diameter relative to the other cone on the input shaft/spline after the “First axial position changing of a cone”, or for which its cone on the output shaft/spline has the larger transmission diameter relative to the other cone on output shaft/spline after the “First axial position changing of a cone”.

For a cone on the input shaft/spline, the cone's direction of rotation that increases the tension in the tense side of its transmission belt is in the direction of rotation of the input shaft/spline. And for a cone on the output shaft/spline, the cone's direction of rotation that increases the tension in the tense side of its transmission belt is in the direction opposite from the rotation of the output shaft/spline.

Once a cone is rotated in the direction that increases the tension in the tense side of its transmission belt in order to “compensate for having cones with different transmission diameters mounted on the same shaft”, the axial position of a cone of “the CVT 4 for which the transmission belt tension was reduced (due to a releasing torque)” can be changed. Here if the CVT 4 for which the transmission belt tension was reduced (due to a releasing torque)” is the “CVT 4 for which a cone is rotated in the direction that increases the tension in the tense side of its transmission belt” then the transmission diameter of the cone on the input shaft/spline can be decreased, or the transmission diameter of the cone on the output shaft/spline can be increased. And if the CVT 4 for which the transmission belt tension was reduced (due to a releasing torque)” is not the “CVT 4 for which a cone is rotated in the direction that increases the tension in the tense side of its transmission belt” then the transmission diameter of the cone on the input shaft/spline can be increased, or the transmission diameter of the cone on the output shaft/spline can be decreased.

The CVT 4 for which a cone has to be rotated in the direction that increases the tension in the tense side of its transmission belt in order to “compensate for having cones with different transmission diameters mounted on the same shaft” is the “CVT 4 for which the transmission belt tension is reduced (due to required compensating rotation)” after the “First axial position changing of a cone”; since for said CVT 4, a cone has to be rotated in the direction that increases the tension in the tense side of its transmission belt in order prevent an excessive increase in tension in the transmission belt of the other CVT 4, and since the torque capacity of an adjuster should be much smaller than the pulling torque of its CVT 6 under all operating conditions so that an adjuster will stall/slip before it can increase the tension in its transmission belt to above the pulling torque of its CVT 6.

### d) Second Axial Position Changing of a Cone Option 1 of 2

After the “First axial position changing of a cone”, if desired the axial position of a cone of the “CVT 4 for which the transmission belt tension is reduced (due to required compensating rotation)” can be changed. The “CVT 4 for which the transmission belt tension is reduced (due to require compensating rotation)” is the CVT 4 for which a cone is rotated in the direction that increases the tension in the tense side of its transmission belt in order to “compensate for having cones with different transmission diameters mounted on the same shaft”.

If the “CVT 4 for which the transmission belt tension is reduced (due to required compensating rotation)” is the CVT 4 for which the axial position of a cone was changed during the “First axial position changing of a cone”, then the tension in this CVT 4 is already reduced after the “First axial position changing of a cone”.

If the “CVT 4 for which the transmission belt tension is reduced (due to required compensating rotation)” is not the CVT 4 for which the axial position of a cone was changed during the “First axial position changing of a cone”, then the tension in the “CVT 4 for which the transmission belt tension is reduced (due to required compensating rotation)” is reduced after the “First axial position changing of a cone” has been completed, and after the slack in the tense side tensioning pulley/support pulley of the CVT 4 for which the axial position of a cone was changed has been exhausted. In order to ensure that the tension in the transmission belt of the “CVT 4 for which the transmission belt tension is reduced (due to required compensating rotation)” has been reduced and that the tensioning pulleys/support pulleys of the “CVT 4 for which the transmission belt tension is reduced (due to required compensating rotation)” are in their required positions, here a slight pause after the “First axial position changing of a cone” can be used before starting the “Second axial position changing of a cone Option 1 of 2”.

Here once the tension in the transmission belt of the “CVT 4 for which the transmission belt tension is reduced (due to required compensating rotation)” has been reduced, when the adjuster used to provide compensating rotation (which is achieved by rotating a cone of said CVT 4 in the direction that increases the tension in the tense side of its transmission belt) is unlocked but the “speed its adjuster motor rotates its adjuster output shaft” is less than the “speed applied on its adjuster output shaft”, then an increase in tension in the slack side of the transmission belt of the “CVT 4 for which the transmission belt tension is reduced (due to required compensating rotation)” can occur; since here the unlocked cone is rotated relative to its shaft due to the pulling tension in the slack side of its transmission belt. As such here the slack side of the transmission belt (which is the slack side of the transmission belt during regular torque transmission) becomes the tense side of the transmission belt, and the tense side of the transmission belt (which is the tense side of the transmission belt during regular torque transmission) becomes the slack side of the transmission belt. Here the tense side tensioning pulley/support pulley and the slack side tensioning pulley/support pulley each should have a sufficient “contracting and extending movement range” to provide and remove slack as needed to allow for axial position changing of their cone during axial position changing of their cone.

Alternately, here once the tension in the transmission belt of the “CVT 4 for which the transmission belt tension is reduced (due to required compensating rotation)” has been reduced; and for the adjuster used to provide compensating rotation, the “speed its adjuster motor rotates its adjuster output shaft” is more or equal than the “speed applied on its adjuster output shaft”, then the larger extending force of the tense side tensioning pulley/support pulley should move the tense side tensioning pulley/support pulley so as to increase its “available contraction distance”, this might cause said adjuster to stall or slowdown until the extending force of the tense side tensioning pulley/support pulley is sufficiently reduced and the extending force of the slack side tensioning pulley/support pulley is sufficiently increased. Here once the tense side tensioning pulley/support pulley and the slack side tensioning pulley/support pulley have reached their equilibrium positions, the tense side tensioning pulley/support pulley and the slack side tensioning pulley/support pulley each should have a sufficient “contracting and extending movement range” to provide and remove slack as needed to allow for axial position changing of their cone during axial position changing of their cone.

Here if it is difficult to balance the tensioning forces of the tense side tensioning pulley/support pulley and the slack side tensioning pulley/support pulley so that they each have a sufficient “contracting and extending movement range”, then it might be acceptable if here the slack side tensioning pulley/support pulley hits its maximum contraction stop before axial position changing of a cone of its CVT 4 is started.

If the slack side tensioning pulley/support pulley hits its maximum contraction stop, then the tense side tensioning pulley/support pulley can only provide slack and the slack side tensioning pulley/support pulley can only remove slack. But, this might be acceptable here, since the adjuster of the CVT 4 for which the axial position of a cone is changed, is rotated in the direction that removes slack from the side of the tense side tensioning pulley/support pulley and provides slack to the side of the slack side tensioning pulley/support pulley. Whether this allows proper axial position changing of a cone for “d) Second axial position changing of a cone Option 1 of 2”, can be determined through experimentation; if it does not, then the tensioning forces of the tense side tensioning pulley/support pulley and the slack side tensioning pulley/support pulley, and the parameters (torque, speed, unlocked frictional resistance) of the active adjuster need to be selected so that each tensioning pulley/support pulley has a sufficient “contracting and extending movement range” to provide and remove slack as needed to allow for axial position changing of a cone by “compensating for Transmission ratio change rotation, by “accommodating for the transmission diameter change of a cone”, and/or by “compensating for having cones of different transmission diameters mounted on the same shaft” during axial position changing of their cone.

Once the tension in the transmission belt of the “CVT 4 for which the transmission belt tension is reduced (due to required compensating rotation)” has been reduced, the axial position of a cone of the “CVT 4 for which the transmission belt tension is reduced (due to required compensating rotation)”, can be changed.

Here if the cone which axial position was changed under “c) First axial position changing of a cone” was on the input shaft/spline; then for “d) Second axial position changing of a cone Option 1 of 2”, the transmission diameter of the smaller cone on the input shaft/spline needs to be increased so that its transmission diameter is equal to the transmission diameter of the other cone on the input shaft/spline”.

And if the cone which axial position was changed under “c) First axial position changing of a cone” was on the output shaft/spline; then for “d) Second axial position changing of a cone Option 1 of 2”, the transmission diameter of the larger cone on the output shaft/spline needs to be decreased so that its transmission diameter is equal to the transmission diameter of the other cone on the output shaft/spline”.

After “d) Second axial position changing of a cone Option 1 of 2”, the adjuster that is used to “compensate for having cones with different transmission diameters mounted on the same shaft” can be stopped, since after “d) Second axial position changing of a cone Option 1 of 2”, the CVT 6 will be at “a) Initial Setup/Regular Operation Setup”, where the transmission diameters of all cones mounted on the same shaft/spline are equal.

### e) Second Axial Position Changing of a Cone Option 2 of 2

After the “First axial position changing of a cone”, if desired the axial position of a cone of the “CVT 4 for which the transmission belt tension is not reduced (due to required compensating rotation)” can be changed.

Here first the transmission belt tension of the “CVT 4 for which the transmission belt tension is not reduced (due to required compensating rotation)” needs to be reduced. This is accomplished by rotating a cone of the “CVT 4 for which the transmission belt tension is not reduced (due to required compensating rotation)” in the direction that reduces the tension in its transmission belt. This should also be the direction to “compensate for having cones with different transmission diameters mounted on the same shaft”; this is because the direction of rotation of the “CVT 4 for which the transmission belt tension is reduced (due to required compensating rotation)” is in the direction that increases its transmission belt tension, and the direction of rotation to “compensate for having cones with different transmission diameters mounted on the same shaft” of one CVT 4 should be opposite from that of the other CVT 4. As such here, a cone of the “CVT 4 for which the transmission belt tension is not reduced (due to required compensating rotation)” needs to be rotated in the direction that reduces the tension in its transmission belt (which is also the direction of rotation to “compensate for having cones with different transmission diameters mounted on the same shaft”) as long as there are cones with different transmission diameters mounted on the same shaft.

And since here the rotation to reduce the transmission belt tension of the “CVT 4 for which the transmission belt tension is not reduced (due to required compensating rotation)” also compensates for having cones with different transmission diameters mounted on the same shaft, here the rotation of a cone to compensate for having cones with different transmission diameters mounted on the same shaft of the “CVT 4 for which the transmission belt tension is reduced (due to required compensating rotation)” can be slowed down and eventually stopped.

After rotation to reduce the transmission belt tension of the “CVT 4 for which the transmission belt tension is not reduced (due to required compensating rotation)” is started, the transmission belt tension of the “CVT 4 for which the transmission belt tension is reduced (due to required compensating rotation)” will become not reduced, and as such the “CVT 4 for which the transmission belt tension is reduced (due to required compensating rotation)” will become the CVT 4 used for torque transmission. Here it is important that the adjuster of the “CVT 4 for which the transmission belt tension is reduced (due to required compensating rotation)”, which is initially rotating in the direction that increases the tension in its transmission belt, will not reverse direction and rotate in the direction that reduces the tension in its transmission belt. Since if both adjusters rotate in the direction that reduces the tension in their transmission belts, then relocking the adjusters can require a large torque. If necessary, here the adjuster of the “CVT 4 for which the transmission belt tension is reduced (due to required compensating rotation)” applies a braking torque to ensure that said adjuster will not reverse direction, but instead slow-down and eventually stops and becomes locked; other means for braking the rotating cone of the “CVT 4 for which the transmission belt tension is reduced (due to required compensating rotation)” can also be used.

Once the adjuster of the “CVT 4 for which the transmission belt tension is reduced (due to required compensating rotation)” becomes locked, the transmission belt tension of its CVT 4 will become not reduced, and as such its CVT 4 will become the CVT 4 used for torque transmission.

Here once the tension in the transmission belt of the “CVT 4 for which the transmission belt tension was not reduced (due to required compensating rotation)”, which from now on will be referred to as the “CVT 4 for which the transmission belt tension is reduced (due to compensating rotation)”, has been reduced; when the adjuster used to provide compensating rotation (which is achieved by rotating a cone of said CVT 4 in the direction that decreases the tension in the tense side of its transmission belt) is unlocked but the “speed its adjuster motor rotates its adjuster output shaft” is less than the “speed applied on its adjuster output shaft”, then an increase in tension in the tense side of the transmission belt of the “CVT 4 for which the transmission belt tension is reduced (due to compensating rotation)” can occur; since here the unlocked cone is rotated relative to its shaft due to the pulling tension in the tense side of its transmission belt. Here the tense side tensioning pulley/support pulley and the slack side tensioning pulley/support pulley each should have a sufficient “contracting and extending movement range” to provide and remove slack as needed to allow for axial position changing of their cone during axial position changing of their cone.

Here if it is difficult to balance the tensioning forces of the tense side tensioning pulley/support pulley and the slack side tensioning pulley/support pulley so that they each have a sufficient “contracting and extending movement range”, then it might be acceptable if here the tense side tensioning pulley/support pulley hits its maximum contraction stop before axial position changing of a cone of its CVT 4 is started.

If the tense side tensioning pulley/support pulley hits its maximum contraction stop, then the tense side tensioning pulley/support pulley can only remove slack and the slack side tensioning pulley/support pulley can only provide slack. But, this might be acceptable here, since the adjuster of the CVT 4 for which the axial position of a cone is changed, is rotated in the direction that provides slack to the side of the tense side tensioning pulley/support pulley and removes slack from the side of the slack side tensioning pulley/support pulley. Whether this allows proper axial position changing of a cone for “e) Second axial position changing of a cone Option 2 of 2”, can be determined through experimentation; if it does not, then the tensioning forces of the tense side tensioning pulley/support pulley and the slack side tensioning pulley/support pulley, and the parameters (torque, speed, unlocked frictional resistance) of the active adjuster need to be selected so that each tensioning pulley/support pulley has a sufficient “contracting and extending movement range” to provide and remove slack as needed to allow for axial position changing of a cone by “compensating for Transmission ratio change rotation, by “accommodating for the transmission diameter change of a cone”, and/or by “compensating for having cones of different transmission diameters mounted on the same shaft” during axial position changing of their cone.

Once the tension in the transmission belt of the “CVT 4 for which the transmission belt tension is reduced (due to compensating rotation)” has been reduced, the axial position of a cone of the “CVT 4 for which the transmission belt tension is reduced (due to compensating rotation)”, can be changed.

If the cone which axial position was changed under “c) First axial position changing of a cone” was on the input shaft/spline; then for “e) Second axial position changing of a cone Option 2 of 2”, the transmission diameter of the larger cone on the input shaft/spline needs to be decreased so that its transmission diameter is equal to the transmission diameter of the other cone on the input shaft/spline”.

And if the cone which axial position was changed under “c) First axial position changing of a cone” was on the output shaft/spline; then for “e) Second axial position changing of a cone Option 2 of 2”, the transmission diameter of the smaller cone on the output shaft/spline needs to be increased so that its transmission diameter is equal to the transmission diameter of the other cone on the output shaft/spline”.

After “e) Second axial position changing of a cone Option 2 of 2”, the adjuster that is used to “compensate for having cones with different transmission diameters mounted on the same shaft” can be stopped, since after “e) Second axial position changing of a cone Option 2 of 2”, the CVT 6 will be at “a) Initial Setup/Regular Operation Setup”, where the transmission diameters of all cones mounted on the same shaft/spline are equal.

### Details Regarding “Transmission Ratio Change Rotation” in a CVT 6 (“Belt Curvature Change Rotation”

As described earlier, Point N is the contact point between a cone and its transmission belt that doesn't rotate due to changes in the transmission diameter of said cone; and Point M of a cone is the point were no rotational sliding between said cone and its torque transmitting member occur due to axial position change of said torque transmitting member relative to said cone (see FIG. 6 for an example).

As the transmission diameter of a cone is increased, the length of the portion of the transmission belt covering the cone has to be increased; and as the transmission diameter of a cone is decreased, the length of the portion of the transmission belt covering the cone has to be decreased. Increasing the length of the portion of the transmission belt covering the cone requires that the portion(s) of the transmission belt to the left and/or to the right of Point N are slid towards Point N so as to provide more slack; this cause relative rotational movement between the surface of the cone and its transmission belt except at Point N. And decreasing the length of the portion of the transmission belt covering the cone requires that the portion(s) of the transmission belt to the left and/or to the right of Point N are slid away from Point N so as to remove slack; this also cause relative rotational movement between the surface of the cone and its transmission belt except at Point N. “Transmission ratio change rotation” due to the relative rotational movement (sliding) between the surface of a cone and its transmission belt as described in this paragraph is referred to as “belt curvature change rotation”.

The direction of “belt curvature change rotation” depends on the position of Point M relative to Point N, and whether the transmission diameter of the cone is increased or decreased. When Point M is positioned at Point N, “belt curvature change rotation” should be zero; and when Point M is positioned to the left of Point N, the direction of “belt curvature change rotation” should be in the opposite direction from when Point M is positioned to the right of Point N. The location of Point N and the directions of “belt curvature change rotation” can be obtained through experimentations using a Test CVT.

The amount of “belt curvature change rotation” of a cone depends on the distance of the Point M of said cone from Point N. If we ignore the rotations of said cone due to the rotations of its CVT 6 (for illustrative purposes let's assume that the CVT 6 of said cone is not rotating), then the length of the transmission belt segment from Point N to Point M remains constant as the axial position of said cone is changed. If this transmission belt segment is longer than more “belt curvature change rotation” will occur during transmission diameter change of said cone.

For example, for 0.2 tooth long transmission belt segment, “belt curvature change rotation” will be due to the change in curvature of that 0.2 tooth. And for a 6 tooth long transmission belt segment, “belt curvature change rotation” will be due to the change in curvature of those 6 teeth. Obviously “belt curvature change rotation” for 6 teeth is larger than that of 0.2 tooth.

As a cone is rotating due to rotations of its CVT 6, “belt curvature change rotation” for said cone should continuously decrease when its Point M rotates towards Point N, and should continuously increase when its Point M rotates away from Point N.

### Details Regarding “Transmission Ratio Change Rotation” in a CVT 6 (“Member Curvature Change Rotation”)

“Transmission ratio change rotation” of a cone can also be due to the change in curvature of the torque transmitting member of said cone. This type of “Transmission ratio change rotation” is referred to as “member curvature change rotation”.

The amount of “member curvature change rotation” depends on the distance from “Point M of the torque transmitting member of said cone” to “the point of engagement between said torque transmitting member and its transmission belt”. “The point of engagement between said torque transmitting member and its transmission belt”, will be referred to as Point E.

If we ignore the rotations of said cone due to the rotations of its CVT 6 (for illustrative purposes let's assume that the CVT 6 of said cone is not rotating), then the length of the torque transmitting member segment from Point M to Point E remains constant as the axial position of said cone is changed. If this torque transmitting member segment is longer than more “member curvature change rotation” will occur during transmission diameter change of said cone.

For example, for 0.2 tooth long torque transmitting member segment, “belt curvature change rotation” will be due to the change in curvature of that 0.2 tooth. And for a 6 tooth long torque transmitting member segment, “member curvature change rotation” will be due to the change in curvature of those 6 teeth. Obviously “member curvature change rotation” for 6 teeth is larger than that of 0.2 tooth.

The direction of “member curvature change rotation” depends on the position of Point M relative to Point N, and whether the transmission diameter of the cone is increased or decreased. When Point M is positioned at Point N, “member curvature change rotation” should be zero; and when Point M is positioned to the left of Point N, the direction of “belt curvature change rotation” (if it is not zero) should be in the opposite direction from when Point M is positioned to the right of Point N. The directions of “member curvature change rotation” can be obtained through experimentations using a Test CVT.

### Example of “Transmission Ratio Change Rotation” in a CVT 6

As an example, let's say we have a CVT 6 that uses two CVT 4's for which the tensioning pulleys are positioned on the slack side of the transmission belt. And said CVT 6 uses cones that each have the design of a “cone assembly with one torque transmitting member” described in the “Alternate CVT's” section of U.S. Pat. No. 7,722,490 B2.

And for said CVT 6, the cones on the input shaft have the longitudinal slides mounted ends of their torque transmitting members at the leading end (which is the end of the torque transmitting member that engages first), and the cones on the output shaft have the longitudinal slides mounted ends of their torque transmitting members at the trailing end (which is the end of the torque transmitting member that engages last).

The longitudinal slide mounted end of a torque transmitting member is Point M of the torque transmitting member, which is a point of the torque transmitting member which rotational position relative to its cone does not change as the axial position of the torque transmitting member relative to its cone is changed.

A CVT 4 of the CVT 6 (a CVT 6 has two functionally identical CVT 4's) of this section is shown as a front-view in FIG. 6. The following labeling are used for FIG. 6: Driving Cone 9, Torque Transmitting Member 9-M1, Driven Cone 10, Torque Transmitting Member 10-M1, Input Spline 11, Output Spline 12, Support Pulley 14, Tensioning Pulley 13. For Driving Cone 9 and Driven Cone 10, the rotational position of their Point M, which for each cone is located at the end of the torque transmitting member that is mounted to the longitudinal slide, are marked with M; and the rotational position of their Point N, are marked with N.

For this CVT 6 all cones are mounted on an adjuster. And in order to compensate/allow for “Transmission ratio change rotation” in a CVT 4, the adjuster 8 of the cone on the input spline and the adjuster 8 of the cone on the output spline of said CVT 4 are rotated in the same direction during the axial position change of a said cone.

First, let us look at the “12 to 9 o'clock interval” of Driving Cone 9, here when Point M is positioned near the 12 o'clock position, then Point M is positioned to the right of Point N. Here if the transmission diameter of Driving Cone 9 is increased, the “belt curvature change rotation” is counter-clockwise; and if the transmission diameter of Driving Cone 9 is decreased, then the “belt curvature change rotation” is clockwise.

If the axial position of Driving Cone 9 is changed such that its circumference increases or decreased by one tooth (as needed to allow for proper engagement), then for the configuration shown in FIG. 6, the maximum “belt curvature change rotation” for the portions of the transmission belts covering the surfaces of Driving Cone 9 to the left and to the right of Point N is “half a tooth”.

For the “12 to 9 o'clock interval” of Driving Cone 9, the ball park rotational speed and angular acceleration of the adjusters 8 can be estimated by assuming that the maximum “belt curvature change rotation” for the portion of the transmission belt to the right of Point N of “half a tooth” has to be compensated/allowed as Point M is rotated from the 12 o'clock position to the 9 o'clock position. Here the distance that needs to be traveled is “half a tooth”, and the time the distance needs to be traveled is the time it takes to rotate Point M from the 12 o'clock position to the 9 o'clock position.

The estimate of the previous paragraph is very conservative, since the axial position changing of Driving Cone 9 should be started when the not-Point M end of Torque Transmitting Member 9-M1 disengages with its transmission belt. As such, the speed of “belt curvature change rotation” due to the axial position change of Driving Cone 9 near the 12 o'clock position is very low since it starts at zero and then continually accelerates as it approaches the 9 o'clock position. And since the amount of “belt curvature change rotation” also depends on the distance of Point M from Point N; at the maximum distance between Point M from Point N, the amount of “belt curvature change rotation” is maximum (which here is “half a tooth”); and as Point M rotates towards Point N it continually decreases until it reaches zero. We roughly estimate that this will reduce the required rotational speed and angular acceleration by about a half to a quarter (with more time an accurate equation can be obtained).

Therefore, here instead of using a distance of “half a tooth”, we can use a distance of “half a tooth” to an “eight of a tooth” in calculating the ball park rotational speed and angular acceleration for the “12 to 9 o'clock interval” of Driving Cone 9. This estimate is only due to “belt curvature change rotation”, since for the “12 to 9 o'clock interval” of Driving Cone 9, “member curvature change rotation” for Driving Cone 9 is zero; this is because the distance from “Point M” to “Point E (which here is the point of engagement between said torque transmitting member and its transmission belt at the Point M end of said torque transmitting member)” is zero.

Next we look at the “9 to 3 o'clock interval” of Driving Cone 9. When Point M of Driving Cone 9 has rotated to Point N (which is at the 9 o'clock position), the direction of rotation of “Transmission ratio change rotation” (which here is only due to “belt curvature change rotation”) will change. When Point M is at Point N “Transmission ratio change rotation” is zero. And as Point M rotates away from Point N, “belt curvature change rotation” will continue to increase.

And once Point M has rotated so that it is not engaged with its transmission belt anymore (which is close to the 4.5 o'clock position), “member curvature change rotation” will become non-zero and continue to increase; since the distance from “Point M” to “Point E (which here is the point of engagement between said torque transmitting member and its transmission belt at the not-Point M end of said torque transmitting member)” continuous to increase.

For the “9 to 3 o'clock interval” of Driving Cone 9, in order to determine the ball park rotational speed and angular acceleration of the adjusters 8, we use “half a tooth” (which is due to “belt curvature change rotation”) plus “one tooth” (which is due to “member curvature change rotation”) for the distance, and the time the distance needs to be traveled is the time it takes to rotate Point M from the 9 o'clock position to the 3 o'clock position.

As explained previously the movements of a tensioning pulley, such as Tensioning Pulley 13, can also be used to provide and remove slack as needed in order to allow for “Transmission ratio change rotation” due to movements in the slack side of the transmission belt. For Driving Cone 9, Tensioning Pulley 13 cannot allow for “Transmission ratio change rotation” when Point M is positioned to the right of Point N (since here it is due to movements in the tense side of the transmission belt), but it can allow for “Transmission ratio change rotation” when Point M is positioned to the left of Point N, as is the case for the “9 to 3 o'clock interval” of Driving Cone 9 (since here it is due to movements in the slack side of the transmission belt).

Since we use Tensioning Pulley 13 to allow for “Transmission ratio change rotation” due to movements in the slack side of the transmission belt, the distance due to “belt curvature change rotation” for the “9 to 3 o'clock interval” of Driving Cone 9 can be eliminated, so that said distance becomes “one tooth” (which is due to “member curvature change rotation”). This distance is a conservative estimate, since the distance of “one tooth” due to “member curvature change rotation” is covered during the entire duration that the axial position of Driving Cone 9 is changed and not only the “9 to 3 o'clock interval” of Driving Cone 9.

Next we look at the “9 to 3 o'clock interval” of Driven Cone 10. Here the distance that needs to be provided by the adjusters 8 in order to compensate for “Transmission ratio change rotation” as Point M of Driven Cone 10 is rotated from the 9 o'clock position to the 3 o'clock position can be estimated to be “half a tooth” (which is due to “belt curvature change rotation”) plus “one tooth” (which is due to “member curvature change rotation”).

But since “Transmission ratio change rotation” for the “9 to 3 o'clock interval” of Driven Cone 10 occurs on the slack side of the transmission belt, here we use Tensioning Pulley 13 to allow for “Transmission ratio change rotation” due to “belt curvature change rotation”, so that said distance becomes “one tooth” (which is due to “member curvature change rotation”). This distance is a conservative estimate, since the distance of “one tooth” due to “member curvature change rotation” is covered during the entire duration that the axial position of Driven Cone 10 is changed and not only the “9 to 3 o'clock interval” of Driven Cone 10.

Next we look at the “3 to 12 o'clock interval” of Driven Cone 10. When Point M of Driven Cone 10 has rotated to Point N (which for Driven Cone 10 is at the 3 o'clock position), the direction of rotation of “Transmission ratio change rotation” (which here is only due to “belt curvature change rotation”) will change. When Point M is at Point N “Transmission ratio change rotation” is zero. And as Point M rotates away from Point N, “belt curvature change rotation” will continue to increase. Here the distance that needs to be provided by the adjusters 8 in order to compensate/allow for “Transmission ratio change rotation” as Point M of Driven Cone 10 is rotated from the 3 o'clock position to the 12 o'clock position can be estimated to be “half a tooth” (which is due to “belt curvature change rotation”) plus “zero” (which is due to “member curvature change rotation”).

But, the CVT 6 of this example is designed so that the actual distance to compensate for “Transmission ratio change rotation” for the “3 to 12 o'clock interval” of Driven Cone 10 is less than “half a tooth”. If we estimate that the axial position of Driven Cone 10 is changed during an interval from “9 to 12 o'clock”, then the “3 to 12 o'clock interval” represents only ⅓ of the total arc length of the “9 to 12 o'clock” interval. In addition, it is desirable to complete the majority of the axial position changing movement of a cone early on so that the end portion of the axial position changing procedure can be used to reduce the speed of the cone so as to minimize shock loads. If the axial position changing movement of Driven Cone 10 is less than half of the total movement, then the distance to compensate/allow for “Transmission ratio change rotation” should also be less than “half a tooth”, since the maximum amount of “Transmission ratio change rotation” of a cone (ignoring reduction due to the distance of Point N from Point M) is proportional to the amount of the axial movement of a cone. Note, the actual interval for changing the axial position of Driven Cone 10 might be different than the estimate given above; changing the axial position of Driven Cone 10 (and also Driving Cone 9) should be performed during an interval that starts after the trailing end of its torque transmitting member disengages, and ends before the leading end of its torque transmitting member re-engages.

After going through all the operating conditions of the adjusters 8, we conclude that the most demanding requirement for the adjusters 8 occur during the “3 to 12 o'clock interval” of Driven Cone 10, for which the distance that needs to be traveled is “half a tooth”. If at the smallest transmission diameter of a cone the transmission circumference is 20 teeth, then the arc length of “half a tooth” is 0.5/20×360 degrees=9 degrees=0.157 radians. The “3 to 12 o'clock interval” covers 90 degrees, if the maximum operating rpm speed of a cone is 6000 rpm, then t (time)=90 degrees/(6000×360 degrees/60 seconds)=0.0025 seconds. The required rotational angular acceleration is =2×0.157 radians/(0.0025 seconds)̂2=50240 radians/secondŝ2. The required rotational speed is=12560×0.005 radians/seconds=1199 rpm.

From the angular acceleration, the torque requirement of the adjusters 8 can be calculated. Here we assume that each adjuster 8 comprises of an electric motor that drives a worm gear that drives a gear. The Torque (T)=I×angular acceleration. For I, we use the estimate for the inertia of the worm gear which is I=0.5×m×r̂2=0.5×0.3 kg×(0.008 m)̂2=9.7×10̂−6 kg m̂2. Plugging everything in we get T=9.7×10̂−6×12560 Nm=0.49 Nm. This torque estimate does not include the torque required to overcome friction, this torque can be calculated/estimated separately and added to torque estimate above.

If the “input/output ratio” of the worm gear-gear drive is not 1:1, then appropriate adjustments need to be made to the calculations of the previous paragraphs in order to determine the ratings for the motors that drive the worm gears of the adjusters 8. It might also be desirable to use some gearings that increase the output speed of said motors, but reduce the output torque of said motors and add additional inertia that needs to be accelerated by said motors.

Through trial-and-error and experimentation, this ball park estimate can then be used to obtain the actual required speed and torque ratings of the adjuster(s) 8 that allow the axial positions of Driving Cone 9 and Driven Cone 10 to be changed without interruption due to “Transmission ratio change rotation” for the maximum operating speed of the CVT, by simply testing the at what minimum speed and minimum torque of the adjuster(s) 8 the axial positions of Driving Cone 9 and Driven Cone 10 can changed without interruption due to “Transmission ratio change rotation” at the maximum operating speed of the CVT.

As the speed of a worm gear-gear drive increases, its “locking friction” can drop to less than half its static “locking friction”. And as such, at high speeds the “worm rotating force” of a worm gear-gear drive might be larger than the “worm locking force” and can be used to accelerate and rotate the worm gear as required to compensate/allow for “Transmission ratio change rotation”. If this is so, then the speed requirements of the motors of the adjusters 8 can be limited to the speed at which the “locking friction” will drop significantly to allow the “worm rotating force” to accelerate and rotate the worm gear as required to compensate/allow for “Transmission ratio change rotation”. It is recommended that the motors of the adjusters 8 are always ON when the adjusters 8 are needed to compensate/allow for “Transmission ratio change rotation”, even when the adjusters 8 are driven by the “Transmission ratio change rotation”; this is to account for sudden decrease in speed and increase in “locking friction” of the worm gear-gear drive. Throughout this application, for an adjuster that has a worm gear-gear drive, the definition of an unlocked adjuster is an adjuster for which the “worm rotating force” of its worm gear-gear drive is larger than the “worm locking force” of its worm gear-gear drive.

If two adjusters 8 on a common shaft are used to compensate/allow for “Transmission ratio change rotation”, then the adjuster 8 on the shaft that is transmitting torque and that is rotating in the opposite direction of a releasing torque, can become unlocked as to freewheel (not transmitting any torque). This can occur as the adjuster 8 reverses direction while rotating under non-static friction. If the adjuster 8 does not have sufficient torque to prevent freewheeling, freewheeling can be stopped by temporarily disengaging the CVT from its source of power and then using the motor of the adjuster 8 as needed to lock its adjuster 8. This method can be used to stop freewheeling for all situation.

Just getting a CVT 6 to work can be easily achieved by limiting the demand (torque & speed) of the CVT 6 and/or by selecting adjusters 8 with sufficient amount of torque and speed. The purpose of the additional description of the previous paragraphs is to provide additional design options that can be used to design a more cost-effective CVT 6.

### Miscellaneous Details for a CVT 6

For the CVT 6 shown in FIG. 6, a cone that has the longitudinal slide mounted end of its torque transmitting member at the trailing end, can be the mirror image of a cone that has the longitudinal slide mounted end of its torque transmitting members at the leading end; except that if non-symmetrical teeth are used, then for both cones the teeth for their torque transmitting members should be oriented so that they can transfer maximum torque in the direction they are primarily used for torque transmission.

The designation “leading end” and “trailing end” for the ends of the torque transmitting member of the example of a “cone assembly with one torque transmitting member” described in the “Alternate CVT's” section of U.S. Pat. No. 7,722,490 B2 were arbitrarily selected. Obviously the part of a cone referred to as the “leading end” can be used as the leading end of a torque transmitting member (which is the end of a torque transmitting member that engages first) or the “trailing end” of a torque transmitting member (which is the end of a torque transmitting member that engages last), and likewise the “trailing end” part of a cone can also be used as the “leading end” or “trailing end” of a torque transmitting member.

The required relative rotation between the cones on a common shaft/spline to compensate for “Transmission ratio change rotation” can also be provided by adjuster(s) 8 of the CVT 4 other then the CVT 4 for which for a cone rotation to allow for “Transmission ratio change rotation” is required. The same direction of relative rotation between the cones, as described earlier, need to be provided by said adjuster(s) 8. However, here the torque required by the adjuster(s) might be larger.

The cones of a CVT 6 should be designed so that they can handle the maximum releasing torque and the maximum torque due to the “rotations to compensate for having cones with different transmission diameters mounted on the same shaft”. The pulling direction of a releasing torque is in the direction that increases the tension in the slack side of the transmission belt. And the pulling direction due to the “rotations to compensate for having cones with different transmission diameters mounted on the same shaft” is in direction that increases the tension in the slack side of the transmission belt when a cone on the input shaft is pulled in the direction its CVT is rotating by the cone to which it is coupled (which should happen occasionally for the preferred CVT 6), and when a cone on the output shaft is pulled in the opposite direction its CVT is rotating by the cone to which it is coupled (which should also happen occasionally for the preferred CVT 6). The pulling direction in the direction that increases the tension in the slack side of the transmission belt is opposite from the main pulling direction of the cones, which is in the direction that increases the tension in the tense side of the transmission belt. As such the cones of a CVT 6 should be designed such that can transit torque in both directions as required; although the torque capacity in one direction can be larger than the other.

For a CVT 6, the force needed to change the transmission ratio can be reduced by reducing the tension in the transmission belt of the CVT 4 for which the transmission ratio is changed. The transmission ratio of said CVT 4 can be changed by changing the axial position(s) of the driven cone, driving cone, or both driven cone and driving cone of said CVT 4.

For a CVT 6, it's recommended that during non-transmission ratio changing operation, the transmission diameters of the cones mounted on a common shaft/spline are identical; if this is not the case then the adjuster(s) need to provide rotational adjustments as necessary to compensate for having cones with unequal transmission diameters on a common shaft/spline, which reduces efficiency. The required direction for this rotational adjustment can be obtained through experimentation; here if desired the Test CVT described earlier can be used. Also, it is recommended that here the adjuster(s) provide more adjustments than required or are unlocked so that they can always provide the amount of adjustment needed and only stall or slip when they provide too much adjustment.

Also for the cones of the CVT 6 that do not have an adjuster, it is not necessary to mount them on their spline through the use of a slider. Other means of mounting as described in U.S. patent application Ser. No. 11/978,456, U.S. patent application Ser. No. 13/629,613, and U.S. Pat. No. 7,722,490 B2 can also be used.

A CVT that is identical to the one shown in FIG. 5, except for using an adjuster for each cone, is shown in FIG. 8. The same labeling used for FIG. 5 is used for FIG. 8. For this CVT, the rotational position of one cone at a time of a CVT 4 (driving cone or driven cone) can be rotated by the adjusters into a moveable position during parking. In order to do this, for said CVT 4 the adjusters of the driving cone and driven cone are rotated in a common direction until the cone that was to be rotated into a moveable position is in that position. Here the required rotational speed of the adjusters might be different, this problem can be solved by simply letting the adjuster that rotates too fast stall, slip, and/or slowdown. Once a cone is in a moveable position, its axial position can be changed.

When parked, during the axial position changing procedure of a cone, the adjusters are not required to provide a releasing torque unless there is tension in the transmission belt that needs to be relieved. Here tension in transmission belt is unlikely, especially after the adjusters are used to change the rotational positions of the cones. However, if desired the tension in transmission belt can be relieved by rotating a cone of that transmission belt in both directions, since one direction will be the direction to relieve tension and the torque of the adjusters are limited so that they should not be able significantly increase the tension in a transmission belt in whichever direction they are rotating. The duration of each rotation of the rotations in both directions can be set by a “set time duration” (the earlier description regarding a “set time duration” is also applicable here). When parked, there is no need to “compensate for having cones with different transmission diameters mounted on the same shaft”.

When the adjusters 8 (adjusters) are only used to release tension, compensate/allow for “Transmission ratio change rotation”, and “compensate for having cones with different transmission diameters mounted on the same shaft”, the only control required for the adjusters is ON/OFF and the direction of rotation; since here the adjusters can always be rotated up to their maximum capacity when ON. Under regular driving conditions having to change the transmission ratio of a CVT during parking, for which rotational position control of a cone is required, is not needed. But, if the cost of an adjuster that allows for rotational position control is not cost prohibitive, being able to change the transmission ratio of a CVT during parking allows the CVT to operate optimally even under extreme driving conditions.

A CVT 6 uses two CVT 4's in order to reduce the tension in the transmission belt of one of the CVT 4's. The concept of using two CVT's and mounting at least one means for conveying torque (such as a cone, transmission pulley, variator, etc.) of each CVT using an “adjuster that allows a said means for conveying torque to rotate relative to the shaft/spline on which it is mounted” can also be applied to other CVT's. For example, the same concept can be applied to a CVT that uses two CVT 1's or two CVT 3's of U.S. Pat. No. 7,722,490 instead of two CVT 4's. For the CVT 1's and CVT 3's it is recommended that the cones of these CVT's are cones with two opposite slideable teeth.

CVT 4 with One Adjuster 8

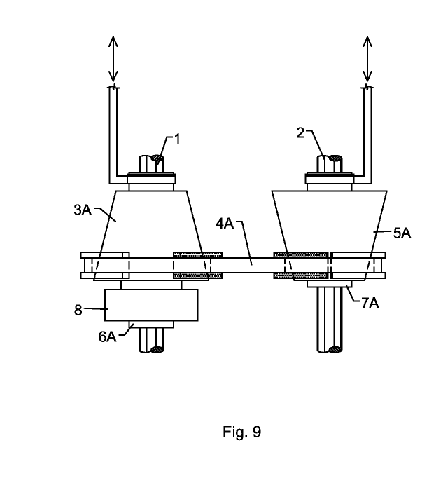

The tension in a transmission belt can also be reduced in a CVT 4 for which one cone is mounted on its shaft/spline using adjuster 8. This configuration is shown in FIG. 9. For this CVT 4, the tension in its transmission belt can be reduced by unlocking the worm gear-gear drive of the adjuster 8 in the direction that reduces the tension in the transmission belt. Here the dynamic friction of the worm gear-gear drive should be low enough so that the gear can drive its worm gear once rotation was initiated by the motor of the adjuster 8. Here in order to increase the tension of the transmission belt which tension was reduced, the worm gear-gear drive of the adjuster 8 should be re-locked. Here it needs to be ensured that the motor of the adjuster 8 has enough torque to do so. And here, unlike CVT 6, the reduction in transmission belt tension depends on the frictional resistance of the worm gear-gear drive. Also here, unlike CVT 6, there is loss of momentum during transmission ratio changing.

CVT with Transmissions
CVT with Pre-Transmission

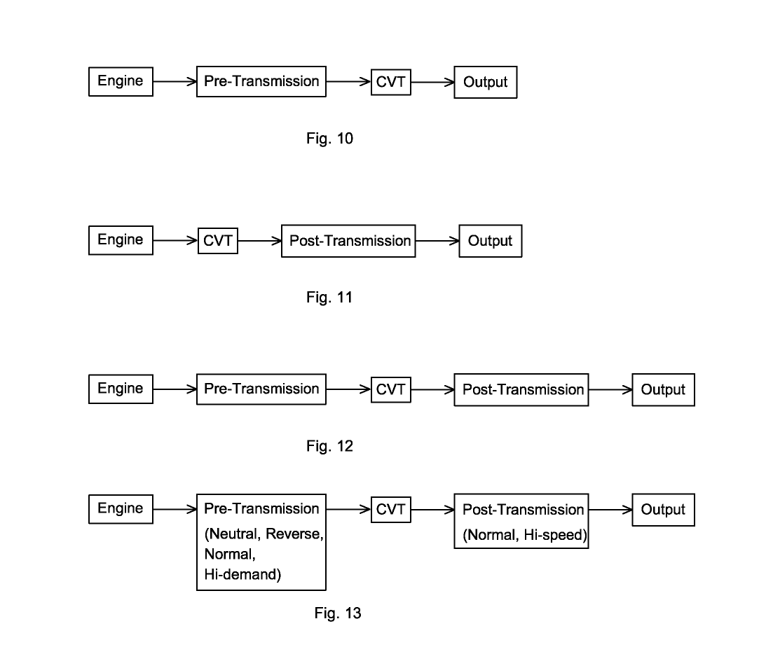

Under most regular driving conditions, the engine of vehicle only revs-up to about half of its maximum rpm. However, under certain driving condition (i.e. driving uphill, towing), the maximum power of the engine is required so that the engine needs to rev-up to its maximum rpm. In order to limit the input speed into a CVT, a transmission, which is referred to as a pre-transmission, can be placed between the engine/motor and the CVT. The pre-transmission should have one gear ratio for regular driving, and at least one gear ratio for high torque driving. The gear ratio for high torque driving should be selected so as to reduce the input speed and increase the torque of the rotation that enters the CVT. If desired, the pre-transmission can also have neutral and/or reverse gearing. A configuration of a drive system using a Pre-transmission is shown in FIG. 10.

The purpose of the Pre-transmission is to limit the maximum rotational speed of a cone. Another method to accomplish this is by limiting the maximum rotational speed cone is allowed to rotate. Here the engine can still be allowed to rotate at its maximum rpm, but the transmission ratio of the CVT should be limited so that the maximum rotational speed of a cone is limited to a pre-set maximum rotational speed for a cone.

CVT with Post-Transmission

Under most regular driving conditions, a vehicle only speeds-up to 80 mph. In order to accommodate for faster speed, a transmission, which is referred to as a post-transmission, can be placed after the output of the CVT. The post-transmission should have one gear ratio for regular driving, and at least one gear ratio for high torque driving. If desired, the post-transmission can also have neutral and/or reverse gearing. A configuration of a drive system using a Post-transmission is shown in FIG. 11.

CVT with Pre-Transmission and Post-Transmission

If desired drive system can also have a pre-transmission and post-transmission, both which are described earlier. A configuration of a drive system using a Pre-transmission and Post-transmission is shown in FIG. 12.

Example of a CVT with a Pre-Transmission and a Post-Transmission

An example drive system that has a pre-transmission, a CVT, and a post-transmission is described below and shown in FIG. 13; it is referred to as a Drive System 1. Obviously many other configurations and control schemes besides the one described in this example can be used for a drive system that has a CVT, and a pre-transmission and/or post-transmission.

The pre-transmission of Drive System 1 has the following gearing: Neutral, Reverse, Normal (for regular demand driving conditions), and Hi-demand (for high demand driving conditions). The Hi-demand gearing can consist of one or several gear ratios.

The post-transmission of Drive System 1 has the following gearing: Normal (for regular speed driving conditions), and Hi-speed (for high speed driving conditions). The Hi-speed gearing can consist of one or several gear ratios.

Let's say we have an engine with redline of 6000 rpm. Under normal driving conditions, running said engine up to 3000 rpm is sufficient. Hence, here we use the Normal gearing of the pre-transmission for engine speeds up to 3000 rpm. And for engine speeds greater than 3000 rpm we use the Hi-demand gearing(s).

Switching between Normal gearing and Hi-demand gearing can be performed automatically or manually. Automatic switching can be performed by a control mechanism that monitors the rpm speed of the engine. And manual switching can be performed by the user whenever he senses a Hi-demand condition, such as driving uphill or towing for example.

The output transmission ratio of Drive System 1 is the transmission ratio involving the pre-transmission, CVT, and post-transmission. A transmission control system, which has the required output transmission ratio for given output speed and demand driving condition programmed into it, is used to control the output transmission ratio of Drive System 1 based on: a) the output speed of Drive System 1; b) whether its pre-transmission is in Normal gearing or Hi-demand gearing (the demand driving condition).

The transmission control system is programmed so that the output transmission ratio for Hi-demand gearing is lower than that for Normal gearing (for a lower transmission ratio, the torque/speed ratio is higher than that of a higher transmission ratio). And programmed so that for each demand driving condition (Normal and Hi-demand), the lower the output speed, the lower the output transmission ratio.

Immediately after switching from Normal gearing to Hi-demand gearing and immediately after switching from Hi-demand gearing to Normal gearing, the output transmission ratio of Drive System 1 is adjusted by the transmission control system based on the output speed of Drive System 1 and the demand driving condition (Normal or Hi-demand). This is accomplished by making adjustments in the CVT and/or Post transmission to reach the required programmed output transmission ratio using the “transmission configuration of Drive System 1” for the demand driving condition.

Regarding the “transmission configuration of Drive System 1”: a) for Hi-demand gearing, as the output transmission ratio is increased from the lowest transmission ratio to the highest transmission ratio, the post-transmission is used before the CVT is used, since for Hi-demand driving conditions the Hi-speed feature of the post-transmission will not be used, and the transmission ratio of the post-transmission can be changed faster than that of the CVT; b) for Normal gearing, as the transmission ratio is increased from the lowest transmission ratio to the highest transmission ratio, the CVT is used first until its highest transmission ratio is reached before the post-transmission is used.

Under most driving conditions Drive System 1 will provide CVT performance, while allowing its CVT to operate at a lower maximum rpm. Like the Hi-demand gearing of the pre-transmission, the Hi-speed gearing of the post-transmission is also only used occasionally. As a numerical example, for a car with 20 inch tires, an engine speed of 3000 rpm, and a 1:1 transmission ratio, the car's speed is =3000 rpm*3.14*20=188400 in/min=287 km/h. Under the same set-up, for an engine speed of 2000 rpm, the car's speed is 191 km/h. If the transmission ratio range of the CVT is from 4:1 (lowest trans. ratio) to 1:1 (highest trans. ratio), then it will be able to provide a car with a speed up to 191 km/h while running the engine up to 2000 rpm, which is in range of normal operating conditions of a car.

### Preferred Embodiment of the Invention (Best Mode)

The preferred design of a CVT 6 (which uses two substantially identical CVT 4's) is a design that uses one adjuster for each CVT 4, and where for each CVT 4 both a slack side tensioning pulley/support pulley and a tense side tensioning pulley/support pulley (which both have contracting and extending movements that are used to provide and remove slack as needed to compensate for “Transmission ratio change rotation”, to accommodate for the transmission diameter change of a cone, and to “compensate for having cones of different diameters mounted on the same shaft during axial position changing of a cone”) are used.

Furthermore, for said preferred design of a CVT 6, both the slack side tensioning pulley/support pulley and the tense side tensioning pulley/support pulley each have a maximum contraction stop.

Furthermore, for said preferred design of a CVT 6, the speed and torque capacity of the adjusters 8 is sufficient to unlock the adjusters 8 when needed and to relock the adjusters 8 when they are “slowing-down and about to change direction”.

Furthermore, for said preferred design of a CVT 6, the adjusters 8 are used to reduce the tension in their transmission belt when required, and to “compensate for having cones with different transmission diameters mounted on the same shaft” when “cones with different transmission diameters are mounted on the same shaft” or immediately before the axial position change of cone where “cones with different transmission diameters are mounted on the same shaft” after said axial position change of cone. The adjusters 8 can also have other uses as long as they don't interfere with the uses above.

Furthermore, for said preferred design of a CVT 6, the axial positions of the cones of a CVT 6 are changed in manner such that when there are “cones with different transmission diameters mounted on a same shaft/spline”, the next axial position change of a cone is always such that the transmission diameters of said “cones with different transmission diameters mounted on a same shaft/spline” are equal. Therefore, since during regular operations (non-“transmission ratio changing” operations) of said preferred design of a CVT 6, the transmission diameters of all cones mounted on the same shaft/spline are equal, there should be only one shaft/spline at a time for which there are “cones with different transmission diameters mounted on a same shaft/spline”.

Furthermore, for said preferred design of a CVT 6, when there are no “cones with different transmission diameters mounted on the same shaft/spline”, in order to “compensate for having cones with different transmission diameters mounted on the same shaft” after axial position changing of a cone, only the “cone which required compensating rotation is in the direction that increases the tension in the tense side of its transmission belt” is rotated/unlocked by its adjuster 8 before, during, and after said axial position changing of a cone. Said adjuster 8 is only slowed-down and eventually locked after “an adjuster 8 of the other CVT 4” is used to “compensate for having cones with different transmission diameters mounted on the same shaft”, or until its rotation is not needed anymore due to a subsequent “axial position changing of a cone” that equalize the transmission diameters of the cones mounted on said same shaft.

Furthermore, for said preferred design of a CVT 6, when there are “cones with different transmission diameters mounted on the same shaft/spline”, before and during axial position changing of a cone, the cone that is used to “compensate for having cones with different transmission diameters mounted on the same shaft” can be rotated by its adjuster 8 in either directions as convenient. Since here after said axial position changing of a cone, the transmission diameters of the cones mounted on said same shaft/spline should be equal; so that here said adjuster 8 can simply be stopped once there is no need to “compensate for having cones with different transmission diameters mounted on the same shaft”.

A top-view of “said preferred design of a CVT 6” is shown in FIG. 5, and a front-view of a CVT 4 of “said preferred design of a CVT 6” is shown in FIG. 6 (both CVT 4's of “said preferred design of a CVT 6” are substantially identical).

For the top-view of “said preferred design of a CVT 6” shown in FIG. 5, the adjusters 8 are mounted on the same spline; however, if desired the adjusters 8 can be mounted on different shafts/splines, since it does not matter on what shaft/spline the adjusters 8 are mounted, as long as each CVT 4 of “said preferred design of a CVT 6” as one adjuster 8.

The preferred invention of this disclosure is described in the “Transmission ratio changing procedure for reducing the torque requirements of the adjusters of a CVT 6” section.

The preferred method of this invention can also be described as a method for efficiently reducing the tension in the transmission belt of a CVT 4 during transmission ratio changing comprising:

a) Using two CVT 4's where the driven cones of the CVT 4's are mounted on a common shaft/spline and the driving cones of the CVT 4's are mounted on a common shaft/spline.
b) Mounting one cone of each CVT 4 to its shaft/spline using an adjuster. Each adjuster can be used to lock its cone to its shaft/spline, rotate its cone clockwise relative to its shaft/spline, and rotate its cone counter-clockwise relative to its shaft/spline.
c) Using a tense side tensioning pulley (also referred to as tensioning pulley/support pulley) and a slack side tensioning pulley (also referred to as tensioning pulley/support pulley) for each CVT 4. Said tense side tensioning pulley and said slack side tensioning pulley each have a sufficient “contracting and extending movement range” to provide and remove slack as needed to allow for axial position changing of a cone.
d) During regular/“non-transmission ratio changing” operations of the CVT 4's, using a configuration where the transmission diameters of all cones mounted on the same shaft/spline (such as the input spline and output spline) are equal.
e) Using the “Method for efficiently changing the transmission ratio” of the next paragraph to change the transmission ratios of the CVT 4's.

The “Method for efficiently changing the transmission ratio” comprises of the following steps:

a) Before a transmission ratio changing procedure is started, the transmission diameters of all cones mounted on the same shaft/spline are equal.
b) Reducing the tension in the transmission belt of “the CVT 4 for which the axial position of a cone is to be changed”, by having the adjuster of “the CVT 4 for which the axial position of a cone is to be changed” rotating its cone relative to its shaft/spline so as to provide a releasing torque, while the adjuster of the other CVT 4 is locked/braked or provides a slower rotating releasing torque. Once the tension in the transmission belt of “the CVT 4 for which the axial position of a cone is to be changed” has been sufficiently reduced, the adjuster used to reduce the tension in the transmission belt of “the CVT 4 for which the axial position of a cone is to be changed” is stopped/locked.
c) Before the axial position of a cone (referred to as the moved cone) is changed, one adjuster of a cone (referred to as the rotated cone) needs to “rotate preferably faster than required” or “have its worm gear-gear drive unlocked” in the direction “the rotated cone will need to rotate in order to “compensate for having cones with different transmission diameters mounted on the same shaft” after the axial position of the moved cone is changed”; here said adjuster can simply stall or slip when its rotation is “not” or “not yet” needed. Here the rotated cone is only “rotated” or “allowed to rotate” in the direction that increases the tension in the tense side of its transmission belt. The moved cone and rotated cone can be part of the same CVT 4 (they can even be the same cone but not necessarily), or each part of a different CVT 4.
d) Once a cone (said rotated cone) is rotated in the direction that increases the tension in the tense side of its transmission belt in order to “compensate for having cones with different transmission diameters mounted on the same shaft”, the axial position of a cone (said moved cone) of “the CVT 4 for which the transmission belt tension was reduced” is changed, this axial position changing of a cone is referred to as the “first axial position changing of a cone”.
e) After said “first axial position changing of a cone”, a “second axial position changing of a cone” has to be performed so that the transmission diameters of all cones mounted on the same shaft/spline are equal again. Said “second axial position changing of a cone” needs to change the axial position of a cone of the “CVT 4 for which transmission belt tension is currently reduced due to compensating rotation” (which is the CVT 4 of said rotated cone), or change the axial position of a cone of the “CVT 4 for which transmission belt tension is currently not reduced” (which is the CVT 4 other than the CVT 4 of said rotated cone). If the axial position of a cone of the “CVT 4 for which transmission belt tension is currently reduced due to compensating rotation” is to be changed, no other steps need to be performed before changing the axial position of a cone. And if the axial position of a cone of the “CVT 4 for which transmission belt tension is currently not reduced” is to be changed, then here first the transmission belt tension of the “CVT 4 for which transmission belt tension is currently not reduced” needs to be reduced; this is accomplished by rotating a cone of the “CVT 4 for which the transmission belt tension is not reduced” in the direction that reduces the tension in its transmission belt, which here will also “compensate for having cones with different transmission diameters mounted on the same shaft”. And since its rotation to “compensate for having cones with different transmission diameters mounted on the same shaft” is no longer required, the adjuster of the other CVT 4 (which is the CVT 4 of said rotated cone) is eventually locked as it slows down. Here it is important that the adjuster of the other CVT 4 will not reverse direction from “rotating in the direction that increases the tension in the tense side of its transmission belt” to “rotating in the direction that reduces the tension in the tense side of its transmission belt”. And after the “second axial position changing of a cone” has been performed, the transmission diameters of all cones mounted on the same shaft/spline are equal again and as such the currently active adjuster (which is “used” or “currently used” to “compensate for having cones with different transmission diameters mounted on the same shaft”) is stopped.

The configuration of said preferred design of a CVT 6 should work even if some description of this disclosure, such as a direction of rotation for example, are incorrect. Some description are provided to help the reader understand the principle of the subject matter disclosed, and not as a theoretical truth (which can be easily verified through simple experimentation).

All other configurations of a CVT 6, such as a CVT 6 that doesn't use a tense side support pulley that can provide or remove slack for example, are also useful and have merit, but they are less preferred. And other control schemes for controlling the adjusters 8 can also be used, but they are less preferred. Other control schemes for controlling the adjusters 8 can be obtained through simple experimentation.

### CONCLUSION, RAMIFICATIONS, AND SCOPE

While my above description contains many specificities, these should not be construed as limitations on the scope, but rather as an exemplification of one or several embodiment(s) thereof. Many other variations are possible.

Accordingly, the scope should be determined not by the embodiment(s) illustrated, but by the appended claims and their legal equivalents.

I claim:

1. A CVT 6 for which the tension in a transmission belt can be reduced, which will reduce the transmission ratio changing force needed, reduce the shock loads that occur during transmission ratio changing, and reduce wear due to transmission ratio changing, comprising:
a) two CVT 4's, each said CVT 4 comprises of a cone, which is a cone with one torque transmitting member, that is coupled by a transmission belt to another cone, which is also cone with one torque transmitting member; for said CVT 6, the driven said cones of said CVT 4's are mounted on a common shaft/spline and the driving said cones of said CVT 4's are also mounted on a another common shaft/spline;
b) two adjusters, one for each said CVT 4;
each said adjuster is used to mount one said cone of its said CVT 4 to its shaft/spline;
each said adjuster can be used to lock its said cone to its said shaft/spline, rotate its said cone clockwise relative to its said shaft/spline, and rotate its said cone counter-clockwise relative to its said shaft/spline;
said adjusters can be used to reduce the tension in a said transmission belt of a said CVT 4 and provide required compensating rotations due transmission ratio changing.

2. The CVT 6 of claim 1, wherein each said CVT 4 also comprises of:
a) a tense side tensioning pulley and a slack side tensioning pulley; each said tense side tensioning pulley and each said slack side tensioning pulley has a sufficient “contracting and extending movement range” to provide and remove slack as needed to allow for axial position changing of a said cone.

3. The CVT 6 of claim 2 wherein the transmission ratio is changed using a “Method for efficiently changing the transmission ratio”, which comprises of the following steps:
a) before a transmission ratio changing procedure is started, the transmission diameters of all cones mounted on the same shaft/spline are equal;
b) reducing the tension in the transmission belt of “the CVT 4 for which the axial position of a cone is to be changed”, by having the adjuster of said “the CVT 4 for which the axial position of a cone is to be changed” rotating its cone relative to its shaft/spline so as to provide a releasing torque, while the adjuster of the other CVT 4 is locked/braked or provides a slower rotating releasing torque; once the tension in the transmission belt of said “the CVT 4 for which the axial position of a cone is to be changed” has been sufficiently reduced, said adjuster used to reduce the tension in the transmission belt of said “the CVT 4 for which the axial position of a cone is to be changed” is stopped/locked;
c) before the axial position of a cone (referred to as the moved cone) is changed, one adjuster of a cone (referred to as the rotated cone) needs to “rotate preferably faster than required” or “have its worm gear-gear drive unlocked” in the direction “the rotated cone will need to rotate in order to “compensate for having cones with different transmission diameters mounted on the same shaft” after the axial position of said moved cone is changed”; here said adjuster can simply stall or slip when its rotation is “not” or “not yet” needed; here said rotated cone is only “rotated” or “allowed to rotate” in the direction that increases the tension in the tense side of its transmission belt;
d) once said rotated cone is rotated in the direction that increases the tension in the tense side of its transmission belt in order to “compensate for having cones with different transmission diameters mounted on the same shaft”, the axial position of said moved cone is changed, this axial position changing of a cone is referred to as the “first axial position changing of a cone”;
e) after said “first axial position changing of a cone”, a “second axial position changing of a cone” has to be performed so that the transmission diameters of all cones mounted on the same shaft/spline are equal again; said “second axial position changing of a cone” needs to change the axial position of a cone of the “CVT 4 for which transmission belt tension is currently reduced due to compensating rotation” (which is the CVT 4 of said rotated cone), or change the axial position of a cone of the “CVT 4 for which transmission belt tension is currently not reduced” (which is the CVT 4 other than the CVT 4 of said rotated cone); if the axial position of a cone of said “CVT 4 for which transmission belt tension is currently reduced due to compensating rotation” is to be changed, no other steps need to be performed before changing the axial position of a cone; and if the axial position of a cone of said “CVT 4 for which transmission belt tension is currently not reduced” is to be changed, then here first the transmission belt tension of said “CVT 4 for which transmission belt tension is currently not reduced” needs to be reduced; this is accomplished by rotating a cone of said “CVT 4 for which the transmission belt tension is not reduced” in the direction that reduces the tension in its transmission belt, and locking the adjuster of the other CVT 4 as it slows down; after said “second axial position changing of a cone” has been performed, the transmission diameters of all cones mounted on the same shaft/spline are equal again and as such the currently active adjuster is stopped.
